(19) United States
(12) Patent Application Publication
(10) Pub. No.: US 2026/0134331 A1
(43) Pub. Date: May 14, 2026

(54) Systems and Methods for Structure-Conforming Generation of Content

(71) Applicant: DeepMind Technologies Limited, London (GB)

(72) Inventors: Ishita Dasgupta, San Francisco, CA (US); Nikita Saxena, San Francisco, CA (US); Isabelle M. Guyon, San Francisco, CA (US); Mathangi Venkatesan, Mountain View, CA (US); Benjamin Jan Pietrzak, San Francisco, CA (US)

(21) Appl. No.: 18/941,524

(22) Filed: Nov. 8, 2024

(51) Int. Cl. G06N 20/00; G06T 11/00

(52) U.S. Cl. CPC G06N 20/00; G06T 11/00

(57) ABSTRACT

Example aspects of the present disclosure provide systems and methods for generating structure-conforming content items. The systems and methods can be provide for obtaining a user prompt descriptive of a content item to be generated; generating element description data, the element description data conforming to a schema, the element description data comprising a listing of descriptors of one or more elements of the content item to be generated; generating the one or more elements of the content item; and generating the content item according to an associated structure of the content item and based on the element description data and the one or more elements.

### FIELD

The present disclosure relates generally to machine learning processes and machine-learned devices and systems. More particularly, the present disclosure relates to systems and methods for structure-conforming generation of content.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

For example, in an aspect, the present disclosure provides a computer-implemented method of generating structure-conforming content items. The method includes obtaining, by a computing system comprising one or more computing devices, a user prompt descriptive of a content item to be generated. The method includes generating, by the computing system, element description data, the element description data conforming to a schema, the element description data comprising a listing of descriptors of one or more elements of the content item to be generated. The method includes generating, by the computing system, the one or more elements of the content item. The method includes generating, by the computing system, the content item according to an associated structure of the content item and based on the element description data and the one or more elements.

In some implementations, generating the element description data and generating the one or more elements are performed using one or more machine-learned models.

In some implementations, the method further includes instructing at least one of the one or more machine-learned models to produce outputs conforming to the schema.

In some implementations, generating the element description data is performed using a first machine-learned model and generating the one or more elements is performed using a second machine-learned model.

In some implementations, n generating the one or more elements of the content item includes: obtaining, by the computing system, a plurality of candidate outputs of the second machine-learned model, the plurality of candidate outputs responsive to the descriptors of the one or more elements; providing, by the computing system, the plurality of candidate outputs of the second machine-learned model to the first machine-learned model; and selecting, by the computing system, the one or more elements of the content item from the plurality of candidate outputs.

In some implementations, the first machine-learned model is or includes a language model and the second machine-learned model is or includes an image generation model.

In some implementations, the image generation model is or includes one or more of a diffusion model or an autoregressive model.

In some implementations, the schema is a JavaScript Object Notation (JSON) schema.

In some implementations, the method further includes: generating, by the computing system, an intermediate content item based on the element description data and the one or more elements, the intermediate content item having a default background; generating, by the computing system, a background prompt descriptive of a background to be generated for the content item; and generating, by the computing system, the background based on the background prompt. In some implementations, generating the content item according to the associated structure of the content item and based on the element description data and the one or more elements is further based on the background.

In some implementations, the method further includes obtaining, by the computing system, a content template for the content item based on the element description data. In some implementations, generating, by the computing system, the content item according to the associated structure of the content item and based on the element description data and the one or more elements is further based on the content template.

In some implementations, obtaining the content template includes obtaining, by the computing system, a diagram type descriptive of a type of a diagram of the content item and selecting, by the computing system, the content template from a plurality of candidate templates based on the diagram type and the element description data.

In some implementations, obtaining the content template includes determining, by the computing system, an arrangement of elements specified by the element description data and generating the content template based on the arrangement of elements specified by the element description data.

In some implementations, the content template is descriptive of one or more display aspects of one or more placeholder elements corresponding to the one or more elements of the content item.

In some implementations, generating the content item further includes applying the display aspects of the one or more placeholder elements to the one or more elements of the content item.

In some implementations, the display aspects include one or more of: position, format, color, style, size, font, border, or effect.

For example, the present disclosure can provide a computing system. The computing system includes one or more processors and one or more non-transitory, computer-readable media storing instructions that, when implemented, cause the one or more processors to perform operations. The operations include obtaining a user prompt descriptive of a content item to be generated. The operations include generating element description data, the element description data conforming to a schema, the element description data including a listing of descriptors of one or more elements of the content item to be generated. The operations include generating the one or more elements of the content item based on the element description data. The operations include generating the content item according to an associated structure of the content item and based on the element description data and the one or more elements.

In some implementations, generating the element description data and generating the one or more elements are performed using one or more machine-learned models.

In some implementations, generating the element description data is performed using a first machine-learned model and generating the one or more elements is performed using a second machine-learned model. In some implementations, generating the one or more elements of the content item includes: obtaining a plurality of candidate outputs of the second machine-learned model, the plurality of candidate outputs responsive to the descriptors of the one or more elements; providing the plurality of candidate outputs of the second machine-learned model to the first machine-learned model; and selecting the one or more elements of the content item from the plurality of candidate outputs.

In some implementations, the operations further include: generating an intermediate content item based on the element description data and the one or more elements, the intermediate content item having a default background; generating a background prompt descriptive of a background to be generated for the content item; and generating the background based on the background prompt; wherein the content item according to the associated structure of the content item and based on the element description data and the one or more elements is further based on the background.

For example, the present disclosure can provide one or more non-transitory, computer-readable media storing instructions that, when implemented, cause one or more processors to perform operations. The operations include obtaining a user prompt descriptive of a content item to be generated. The operations include generating element description data, the element description data conforming to a schema, the element description data including a listing of descriptors of one or more elements of the content item to be generated. The operations include generating the one or more elements of the content item based on the element description data. The operations include generating the content item according to an associated structure of the content item and based on the element description data and the one or more elements.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example computing system for structure-conforming generation of content according to example implementations of the present disclosure;

FIG. 2 is a block diagram of an example computing system for structure-conforming generation of content according to example implementations of the present disclosure;

FIG. 3A is a block diagram of an example computing system for structure-conforming generation of content according to example implementations of the present disclosure;

FIG. 3B is a block diagram of an example computing system for structure-conforming generation of content according to example implementations of the present disclosure;

FIG. 4 is a block diagram of an example computing system for structure-conforming generation of content according to example implementations of the present disclosure;

FIG. 5 is a block diagram of an example computing system for structure-conforming generation of content according to example implementations of the present disclosure;

FIG. 6 is a flow chart diagram illustrating example data items that can be used and/or generated according to example implementations of the present disclosure;

FIG. 7 is an example content item that can be generated according to example implementations of the present disclosure;

FIG. 8A-8D are visualizations of example content templates according to example implementations of the present disclosure;

FIGS. 9A-9C are diagrams illustrating example structure-conforming generation of content according to example implementations of the present disclosure;

FIGS. 10-13 are flow chart diagrams illustrating example methods for structure-conforming generation of content according to example implementations of the present disclosure;

FIG. 14 is a flow chart diagram illustrating an example method for training a machine-learned model according to example implementations of aspects of the present disclosure;

FIG. 15 is a block diagram of an example processing flow for using machine-learned model(s) to process input(s) to generate output(s) according to example implementations of aspects of the present disclosure;

FIG. 16 is a block diagram of an example sequence processing model according to example implementations of aspects of the present disclosure;

FIG. 17 is a block diagram of an example technique for populating an example input sequence for processing by a sequence processing model according to example implementations of aspects of the present disclosure;

FIG. 18 is a block diagram of an example model development platform according to example implementations of aspects of the present disclosure;

FIG. 19 is a block diagram of an example training workflow for training a machine-learned model according to example implementations of aspects of the present disclosure;

FIG. 20 is a block diagram of an inference system for operating one or more machine-learned model(s) to perform inference according to example implementations of aspects of the present disclosure;

FIG. 21 is a block diagram of an example networked computing system according to example implementations of aspects of the present disclosure;

FIG. 22 is a block diagram of an example computing device according to example implementations of aspects of the present disclosure; and

FIG. 23 is a block diagram of an example computing device according to example implementations of aspects of the present disclosure.

### DETAILED DESCRIPTION

Generally, the present disclosure is directed to systems and methods for improved generations of content items to conform structures and formats, such as for improved user-editability. Computer-interpretable content can generally be represented by data (e.g., binary data, text data, signal data, etc.) that is formatted according to a given structure or format. The structure may generally be respective to the type of content. For example, a content item in a computer design system may be formatted such that a computer system can store the data in non-transitory, computer-readable memory (e.g., as bytes of data). As one example, the content may be stored as a string of bytes that are interpretable as characters of text data at least some of which corresponds to text in the content item. Simultaneously, the structure can provide that the computing system can interpret tokens, positions, or other aspects of the structure to consistently display or provide the content to a user in an aesthetically enhanced manner.

In this manner, computing systems can be used as visual and/or audial aids or tools to convey information, generally to human readers, in an audial or visual manner. For example, a slide show design tool may interpret positions and tokens in structured data corresponding to a slide show to signal where and how content will appear on a screen when the slide show is displayed. For instance, text depicted on a slide may be formatted in such a manner as to draw attention to certain portions of the text (e.g., headers, titles, etc.) over other portions of the text (e.g., captions). A slide may have images, graphics, bullets, backgrounds, and other stylistic elements to convey relationships between concepts and/or to make the slide more visually engaging to the viewers of the slide. As an example, slides depicting charts, cycles, processes, and so on may have images associated with each element of the chart, cycle, or process. As another example, text may be arranged on a slide in a positionally varied manner to improve visual variety of the slide or slide show. Other examples of computer-interpretable content that can be used to convey information to users include other forms of infographics and visual content, such as posters, images, decals, canvases, and similar visual content, text content such as documents and notes, three-dimensional design content such as models and prototyping, audio content such as music, audiobooks, podcasts, and various other types of content. Some aspects of the present disclosure are discussed for the purposes of illustration with respect to visual or graphical content, such as slide shows and slides. Aspects of the present disclosure can be equally applicable to other forms of computer-generated content, however, such as the examples given above.

Because of the potential complexity of computer-interpretable content, some creators can employ computer-assisted tools for designing the content, such as machine-learned creation tools. As one example, a human (or another computer agent) may provide a prompt to the tool that describes the content to be generated, and the tool can generate content responsive to the prompt. Some approaches for generating content, however, may fail to seamlessly integrate into human-created projects. For example, a machine-learned slide show creation tool may generate slides resembling conventional slides, but the slides may not conform to conventional slide structures. For example, output of a creation tool employing some conventional machine-learned models, such as machine-learned image generation models, to generate slides may be represented in an image file format, such as a .bmp file, a .jpeg file, a .img file, and so on. The image file format may be, for example, a pixel-based image file format and/or a vector-based image file format. The tool may incorporate the slide images into a file format for a slide show, but the slides themselves may be a single image depicting most or all elements of the slide.

Although some conventional systems can generate interesting content, the computer-generated content may have various discrepancies that a user may wish to modify or alter without entirely discarding the generated content. As one example, the images resembling slides may include inconsistent stylistic elements, clashing flowchart elements, inconsistently formatted text, imprecise borders, or similar elements that a user may wish to change. For these and other reasons, the inability for users to modify the content post-generation can limit user acceptance of the systems. For instance, slides generated as images may not be directly editable by a human in the same manner as a conventional computer-formatted slide (e.g., using editing tools configured to edit .ppt files, editable .pdf files, .odp files, and similar file formats). Because the slide is generated as an image and the user is not able to directly alter the image using conventional design tools, the user must either manually edit the image—a process which, if possible at all, can be significantly time consuming and/or require a different skill set than creating a slide show, which may be beyond the capabilities of the user—or continually regenerate the image until an acceptable slide is created. Continually regenerating the image can frustrate the user and/or waste valuable computing resources associated with running the (often expensive) machine-learned models used by the tool.

In view of the above challenges, example implementations of the present disclosure provide techniques for structure-conforming generation of content. As one example, a computing system can obtain a user prompt, such as a textual prompt, from a user. In some implementations, the user prompt may be gathered through an interface element of a greater content creation tool, such as a slideshow creation tool, video creation tool, and so on. For instance, the user may provide the user prompt through an input field, such as a text input field configured to receive text data, or other suitable input field. The user prompt may be in the form of a query, or “plain language” data as written by the user. For instance, the user prompt can include text data.

The user prompt can describe, for example, the style, content, arrangement, and/or other aspects of a content item that a user seeks to create by a content generation tool. For example, the content item to be generated may be a slide of a slideshow. The user prompt may describe aspects of the slide, such as the content of the slide, color, style, theme, or other stylistic aspects of the slide, and so on. For example, the user prompt may range from a request broadly describing the content to be generated, such as “please generate a slide depicting the life cycle of a chicken” to more specific requests such as “please generate a slide depicting the life cycle of a chicken as a circular diagram in a simple artistic style, using sketch-like drawings.”

According to example aspects of the present disclosure, a computing system can generate a content item responsive to the user prompt with elements that conform to a structure or format (e.g., file format) associated with the content item. The structure may be user-specified or program-specified. For example, the user may select, include in the user prompt, or otherwise indicate a particular structure or format that the user wishes for the content item to conform to. As another example, the structure may be specified based on the type of content item to be generated and/or a larger program or creative tool used to generate the content item. For example, if the user prompt is received from a slide show creation program, such as a program configured to create and edit slide show files (e.g., .ppt files, .odp files, etc.), the content item can be generated to conform to the slide show file format in use by the slide show creation program. By conforming to a structure or format, the generated content can be modified by the user post-generation such that the user can, for example, replace or regenerate only some portion of the content item without entirely discarding the content item.

Example aspects of the present disclosure provide for generation of a variety of types of content items. One example content item is a diagram. For instance, a diagram can be a visual (and/or audiovisual) representation of information represented by a set of elements. The elements can be or can include visual elements, such as images, thumbnails, graphics, and other suitable visual elements. Additionally and/or alternatively, the elements can be or can include textual elements, such as captions, titles, descriptions, headers, citations, emphasis text, and/or other suitable textual elements. Other examples of elements can be or can include stylistic or supporting elements such as transition effects, audio effects, or other suitable elements.

In addition to the information conveyed by the elements themselves, a diagram can provide for an enhanced capacity for conveying information by relying on a shared visual language and conventions for interpretation by a viewer. For instance, meaning of a diagram may be derived not only from the elements themselves, but from the arrangement of the elements, the context in which the elements are presented, and/or relationships between elements (e.g., a thumbnail image and a supporting textual caption). The structure, format, and arrangement of elements within the diagram can convey information about a concept being represented in the image. For example, a diagram can employ spatial relationships such as position, size, and/or shape of elements to convey information about the interrelation of different elements. As one example, a map diagram may provide elements such that the distance between elements in the diagram is representative of a (e.g., scaled) distance between corresponding items described by the elements. As another example, a flowchart diagram may depict an ordering or hierarchy of the elements based on a relative position of the elements within the diagram. Furthermore, in some implementations, a diagram may utilize symbolic relationships, such as specific visual symbols with pre-defined or readily-understood meanings to convey information. For example, electrical circuit diagrams may use particular shapes to represent corresponding electrical components where the meaning of those shapes in the context of a circuit diagram is readily understood to those trained in interpreting circuit diagrams. As another example, a Unified Modeling Language (UML) diagram can utilize various conventions including symbolic connectors and notations to convey information about the structure of computer programs and algorithms, business processes and workflows, and other procedures to those who are trained in interpreting a UML diagram. Additionally or alternatively, in some implementations, relationships between elements may be represented by an understood convention such as, for example, a Venn diagram or network graph, which may or may not necessarily include direct physical correlation between the elements.

As one example, the elements of a diagram may be represented by a set of nodes or vertices representing concepts, objects, entities, and/or other singular aspects of a diagram. Edges or arcs between the nodes can represent relationships or connections between the nodes. The structure of the diagram, such as the arrangement of nodes and edges, can additionally encode information about the system or concept being represented. For instance, the spatial, symbolic, and/or contextual aspects of the structure can convey additional information about the elements that is not necessarily apparent in the elements themselves. A diagram, for example, may be represented as D=(N, E, V, I), where D is the diagram, N is a set of nodes {n₁, n₂ . . . nₙ}, E is a set of edges {e₁, e₂, . . . , eₘ}, V is a visual vocabulary defining structure-conforming attributes of the nodes and edges (e.g., shape, color, size, textual prompt descriptions for rendering by a generative model, textual captions, etc.), and/or I is an interpretation function to map the elements and structure to the intended meaning. The interpretation function, for instance, can be represented by a textual description, object-oriented program, or other algorithmic or mathematical mapping.

In some implementations, to generate a content item, a computing system can generate element description data. The element description data can be or can include a set or listing of descriptors of one or more elements of the content item to be generated. For example, the element description data can describe some or all elements of the content item in a computer-interpretable format, such as plain text or a computer-interpretable data structure such as, for example, a data structure representative of a diagram. For instance, the element description data can be a “skeleton” representation of the elements of a content item, such as text data descriptive of images and captions to be displayed on a slide or graphic.

In some implementations, the element description data can conform to a schema, such as, for example, a JavaScript Object Notation (JSON) schema, an Extended Markup Language (XML) schema, a Comma-Separated Value (CSV) schema, an INI schema, or other suitable schema. The schema can be indicative of syntax and validity of data of the element description data. Additionally or alternatively, the schema can be or can include an API call format. As one example, the element description data can be or can include a JSON file, XML file, or other similar list having delineated and/or ordered values. The values can correspond to the elements of the content item and/or can describe the element. For example, one element description data may include delineated values descriptive of four images representative of the life cycle of a butterfly; e.g., describing in text data the depiction of a butterfly egg on a leaf corresponding to an “egg” stage, a caterpillar on a leaf corresponding to a “larva” stage, a chrysalis hanging from a leaf corresponding to a “pupa” stage, and a butterfly in the air corresponding to an “adult” stage. Other values in the element description data may be descriptive of, for example, titles, captions, arrangements, etc. respective to each stage.

As another example, in some implementations, the element description data can be or can include computer-interpretable data representative of a diagram. For example, the element description data can conform to a data structure format for representing diagrams, such as a data structure format including a set of nodes, a set of edges, a visual vocabulary, and/or an interpretation function. For instance, the element description data can include a set of nodes having descriptors or identifiers associated with the nodes. The nodes may include or reference, for example, a descriptor associated with the subject depicted by an element corresponding to the node. Additionally and/or alternatively, the nodes may include or reference a unique identifier associated with the node. The element description data can define or otherwise include edges between the nodes. For instance, the element description data can include a set or list of the edges in the diagram. As one example, the element description data can include text or other symbolic data describing relationships between nodes through a symbol, such as an arrow symbol. For example, the element description data may include a data item such as “Bird->Owl” where the arrow symbol represents an edge between a “Bird” node and an “Owl” node. As another example, the element description data may include aspects or parameters that can be interpreted by a content editor to specify design aspects of the diagram, such as layout types, themes or styles, or other parameters.

Additionally or alternatively, in some implementations, the computing system can generate the element description data based at least in part on input from a user. For instance, in some implementations, the user may define elements and relationships between elements (e.g., as nodes and edges), visual aspects of the elements, positional relationships, and/or other suitable aspects of the element description data via an element description data design tool. The tool may provide the user with interface elements that provide for the user to place, move, edit, and/or otherwise manipulate the elements of the content item at the level of the element description data. For instance, in some implementations, changes made to the user in the element description data may be reflected in the content item generated by the systems and methods described herein.

The computing system can then generate the one or more elements of the content item to be generated based on the element description data. For instance, the computing system can produce, for some or all (e.g., each of the) elements described by the element description data, a data item that matches the description of a respective element in (e.g., described by) the element description data. As an example, if the element description data describes an element that is “an image depicting a butterfly egg on a leaf,” the computing system can generate an image depicting a butterfly egg on a leaf as the element. As another example, if the element description data describes an element that is “audio of a waterfall” or “a whooshing sound for a transition” the computing system can generate audio data or sound data that resembles the sound of a waterfall or a whooshing sound. The generated element(s) can eventually be combined with other elements to produce a larger content item that is thematically and stylistically consistent while also conforming to a structure associated with the content item, as described further herein. In some implementations, some of the elements (e.g., textual elements) may be defined (e.g., verbatim) in the element description data, while some other of the elements (e.g., visual/image elements) may be generated based on the element description data. For example, in some implementations, a thumbnail image for a node may be generated based on the element description data associated with that node, and a caption for the thumbnail image may be included within the element description associated with the node and reproduced on the content item from the element description data. In some implementations, formatting and/or stylistic elements can be applied to the elements (e.g., textual elements) included within the element description data, even if the content of the elements (e.g., the text itself) is included with the element description data.

In some implementations, the content item can be generated by or using one or more machine-learned models. For instance, in some implementations, generating the element description data and generating the one or more elements can be performed using one or more machine-learned models. In some implementations, a single machine-learned model (e.g., a general-purpose machine-learned model) can perform some or all of the steps described herein. For instance, the machine-learned model can receive the user prompt, generate element description data based on the user prompt, generate elements of the content item based on the user prompt, and/or generate the content item based on the user prompt and elements such that the content item conforms to an associated style. In some implementations, for example, the machine-learned model can be a multi-modal machine-learned model that can generate multiple forms of data in response to different prompts, such as, for example, text data, image data, and/or audio data. As another example, in some implementations, such as if the generated image data is a vector format that may be represented as text, the machine-learned model may be capable of generating different types of text data, such as a content descriptor (e.g., a JSON file) and/or image files (e.g., Scalable Vector Graphics (SVG) files).

Furthermore, in some implementations, the computing system can generate the element description data based at least in part on input from the user (e.g., through a design tool). The machine-learned model may be utilized to generate the elements based on the element description data without necessarily generating the element description data itself. Furthermore, in some implementations, arranging the elements into the content item may be performed by a deterministic algorithm, such as an arranging script or assembling script. In some implementations, the use of a script to arrange the elements, which may be adequately performed by a relatively simpler script or algorithm, can provide for reduced computing resource usage compared to some example approaches that utilize machine-learning algorithms at each stage of generating the content item.

Additionally or alternatively, in some implementations, two or more machine-learned models can perform steps described herein. As one example, generating the element description data can be performed using a first machine-learned model and/or generating the one or more elements can be performed using a second machine-learned model. As one example, the user prompt can be provided to a first machine-learned model. The first machine-learned model can be a model configured to interpret text data, such as a language model (e.g., a large language model). In response to the user prompt, the first machine-learned model can output the element description data. In some implementations, at least one of the one or more machine-learned models can be instructed to produce outputs conforming to the schema. For example, the system can provide instructions to the first machine-learned model instructing it to condition its outputs to conform to the schema prior to providing it with the user prompt. As another example, the element description data can be provided to a second machine-learned model, such as an image generation model. The image generation model may be, for example, a diffusion model or an autoregressive model. In response to the element description data, the second machine-learned model can generate the elements of the content item as specified by the element description data. Based on the element description data, the second machine-learned model can produce elements matching the descriptions of the elements of the content item. For instance, the examples above may cause the second machine-learned model to produce images of a butterfly egg, a caterpillar, a chrysalis, and a butterfly.

In some implementations, the elements can be selected from several potential or candidate outputs of the machine-learned models. For example, the models can be instructed to produce a plurality of outputs, and a desired output can be selected from the plurality of outputs. For instance, in some example implementations, generating the one or more elements of the content item can include obtaining a plurality of candidate outputs of the second machine-learned model. The plurality of candidate outputs can be responsive to the descriptors of the one or more elements in the element description data. For example, each of the candidate outputs may include a plurality of candidate elements that generally correspond to the elements of the element description data, but may be generated by different seeding or other inputs such that the candidate elements corresponding to a given desired element are not necessarily identical.

The computing system can, e.g. by or using another machine-learned model such as the first machine-learned model as an adversarial model, select the one or more elements of the content item from the plurality of candidate outputs. For instance, the plurality of candidate outputs of the second machine-learned model can be provided to the first machine-learned model. The computing system may select an element that scores highly relative to the descriptor of the element from the candidate outputs. In some cases, the elements may be selected from among multiple candidate outputs. For example, a first element may be selected from a first candidate output, and a second element can be selected from a second candidate output. In some implementations, for instance, the first machine-learned model can act as an adversarial model to select the elements from the plurality of candidate outputs. For example, the first machine-learned model can be provided with the plurality of candidate outputs and prompted with a selection prompt based on the user prompt or the element description data. As one example, the selection prompt may be a phrase such as “Which of these images is best at showing <element>” where “<element>” is or is based on the descriptor of an element in the element description data.

In some implementations, the system may generate the content item relative to a type of the content item. For example, in some cases, the content item can be or can include a diagram. As one example, the content item can be a slide of a slideshow that depicts a diagram. The diagram may be a focal portion of the content item (e.g., the slide), but additional elements may be included in the diagram that do not necessarily conform to the selected type of diagram (e.g., a title, a source citation, a legend, etc.). As another example, the content item can be the diagram itself. The computing system can obtain a diagram type descriptive of a type of the diagram. The diagram type can, in some implementations, be specified by the user (e.g., via the user prompt). Additionally or alternatively, the computing system (e.g., the first machine-learned model) can determine a diagram type that represents the content displayed in the diagram.

The diagram type, for example, can relate to the manner in which the elements of the diagram are displayed or positioned. As one example, the diagram type may specify a “cycle” diagram generally depicted as multiple stages positioned in a circular or ovular fashion. For instance, the cycle diagram may be useful for depicting life cycles, weather patterns, iterative steps, and other phenomena that are cyclical in nature. As another example, the type may specify an “ordered” diagram such as one or more stages positioned in a linear fashion. An ordered diagram may be useful for depicting linear processes, flowcharts, and so on. As yet another example, the type may specify an “unordered” diagram such as one or more stages positioned in a seemingly irregular arrangement.

Based on the diagram and/or the number of elements in the content item or diagram, the computing system can select a content template for the content item that is appropriate for the diagram and the content item. For instance, in some implementations, the computing system can select a selected content template of a plurality of candidate templates based on the diagram type and the element description data. Additionally or alternatively, the computing system can select a selected content template based on a number of elements to be displayed in the diagram. For instance, in some implementations, the element description data can include a number of the one or more elements. The element description data can include the number of elements implicitly based on the number of fields and/or explicitly based on a value of a dedicated field describing the number of elements. The selected content template can be selected based on the number of the one or more elements. For instance, if the element description data describes five elements in a diagram, the computing system can select a content template having five placeholder elements.

The computing system can then generate the content item according to the associated structure of the content item and based on the element description data and the one or more elements, and further based on the selected content template. For example, the computing system can position and/or format the elements within the content item based on the selected content template. In some implementations, the content template can be a structural template; for instance, it can be descriptive of one or more display aspects of one or more placeholder elements corresponding to the one or more elements of the content item. The display aspects can be, for example, position, format, color, style, size, font, border, effect (e.g., shading, transition effects, etc.), and other suitable aspects or metadata relative to an element. For instance, the content template can be data descriptive of positional relationships, sizes, formatting, color, and so on for elements of the content item and/or additional (e.g., graphical) elements to be included in the content item, without necessarily being dependent on the content of the elements themselves. As one example, the content template can describe positions of five images in a cyclical diagram in a center of a slide, but may not describe the five images themselves. As another example, the content template may describe that 12 point red Times New Roman font is located at a given position in the infographic, but may not describe the characters of the text.

The content template may be, for example, a template slide of a slideshow editor. The selected content template can be responsive to the display requirements of the element description data. For instance, if the element description data contains four elements and the type of diagram is a cycle diagram, the selected content template may describe four element positions arranged in a cycle. Additionally or alternatively, the selected content template may include arrows or other graphics depicting a cyclical relationship.

As another example, in some implementations, the computing system can generate a content template to “fit” the elements set forth by the element description data. For example, the content template may be procedurally generated based on structural aspects, such as edges, formatting, style, theme, a number of elements, etc. included in the element description data itself (e.g., in contrast to using a pre-defined content template). Elements can be generated as described further herein (e.g., from a description field in the element description data) to fill in respective fields of the content template. As one example, the content template can be generated to include a diagram having nodes arranged to represent the relationships between the nodes (e.g., the edges). For example, relationships between the nodes can be illustrated in the content template by lines, flowchart arrows, or similar graphical elements between corresponding node fields. The content item can be generated by arranging the elements into respective fields in the content template (e.g., through an arranging or assembling script).

Furthermore, in some implementations, the computing system may generate a background for a content item based on the elements of the content item. For example, the background can be thematically consistent with the elements and the other portions of the content item. In some implementations, the background can be generated along with the other elements of the content item. Additionally or alternatively, in some implementations, the background can be generated by a background generation system subsequent to the other elements. For instance, in some implementations, the computing system can generate an intermediate content item based on the element description data and the one or more elements. The intermediate content item can have a default background. For example, the intermediate content item may have a solid black or white background, a transparent background, or other background that is a default for a creation tool.

The computing system can generate a background prompt descriptive of a background to be generated for the content item. For instance, the computing system can generate a background prompt based on the element description data and/or the elements or, additionally or alternatively, based on the intermediate content item that lacks a customized background. For example, the background prompt can describe the background to be generated in plain language (e.g., text data). The computing system can then generate the background based on the background prompt. For example, the computing system can generate a background that is responsive to the background prompt. The background can be, for example, an image, gradient, or other suitable background. Generating the content item according to the associated structure of the content item and based on the element description data and the one or more elements can further be based on the background. For example, the background can be combined with the intermediate content item (e.g., in a background field of the structure) to produce the final content item.

In some implementations, one or more machine-learned models can be used to generate the background. As one example, the first machine-learned model (e.g., the model used to generate the element description data) can generate the background prompt based on the intermediate content item such that the background prompt describes thematic or stylistic elements that are consistent with similar thematic or stylistic elements of the elements of the content item. The second machine-learned model (e.g., the model used to generate the elements) can generate the background based on the background prompt.

Example aspects of the present disclosure provide a number of technical effects and benefits, including improvements to computing technology. For instance, example aspects of the present disclosure provide techniques for structure-conformational creation of infographics. The present disclosure can provide for generating content, such as graphics or slide shows, that are formatted as a standard content creation tool would format the content if it was created by exclusively user input. For example, a slide show generated in accordance with a structure associated with the slide show, as described herein, can include elements that may be directly accessed and edited by a user using conventional design tools after the slide show is generated by the systems and methods described herein. As one example, the infographic can conform to the structure and/or syntax of a conventional infographic file format, such as .ppt, .pptx, editable .pdf, .xml, or other suitable file formats. In particular, example aspects of the present disclosure improve the functioning of computer systems to generate infographics analogous to those familiar to long-time users of those computer systems. Such improvements can provide for improved user trust in the computer systems, increased user engagement and retention of services incorporating aspects of the present disclosure, decreased user frustration when utilizing infographic design tools, increasingly efficient user usage of the computer systems providing reduced computer resource usage (e.g., of cloud design tools), and other benefits.

Additionally, systems and methods according to example aspects of the present disclosure can provide for reduced computer resource usage associated with storing generated infographics. For instance, structure-conforming infographics generated according to example aspects of the present disclosure may be stored more byte-efficiently than image-based infographics, providing for reduced memory usage and reduced compute cycle usage on processing and displaying the infographics.

Additionally or alternatively, example aspects of the present disclosure can provide for improved cohesion of one or more elements on the infographic. For instance, the present disclosure can provide for generating one or more elements (e.g., images) from element description data that describes a condensed representation of the infographic. This can provide for the elements to be generated in a consistent style. For example, each generated image may have a shared artistic style (e.g., photorealistic, line drawing, pencil-shaded, etc.) in contrast to one or more images having distinct artistic styles. Furthermore, example aspects of the present disclosure can provide for reduced computing resource usage associated with users regenerating image-formatted infographics that are undesirable to the user due to non-editable shortcomings and/or thematic inconsistencies.

Various example implementations are described herein with respect to the accompanying Figures.

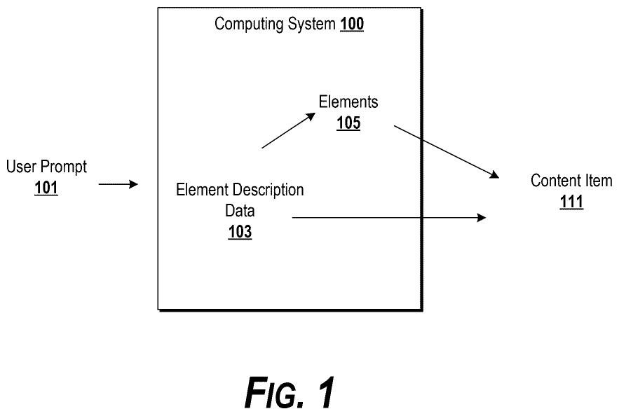

FIG. 1 is a block diagram of an example computing system 100 for structure-conforming generation of a content item 111 according to example implementations of the present disclosure. The computing system 100 can obtain a user prompt 101. For example, a computing system can obtain the user prompt, such as a textual prompt, from a user. For instance, the user may provide the user prompt through an input field, such as a text input field configured to receive text data, or other suitable input field. For example, the user can provide the user prompt 101 to a computing system with the objective of generating a content item 111 using a content creation tool. In some implementations, the user prompt 101 may be gathered through an interface element of a greater content creation tool, such as a slideshow creation tool, video creation tool, and so on. For example, the content item 111 may be a slide of a slideshow.

The user prompt 101 may be in the form of a query, or “plain language” data as written by the user. For instance, the user prompt 101 can include text data. Additionally or alternatively, the user prompt 101 can be descriptive of the content item 111. The user prompt 101 can describe, for example, the style, content, arrangement, and/or other aspects of the content item 111 that a user seeks to create by a content generation tool. The user prompt 101 may describe aspects of the slide, such as the content of the slide, color, style, theme, or other stylistic aspects of the slide, and so on. Additionally or alternatively, the user prompt 101 may not necessarily include every detail of the content item 111. For example, the user prompt 101 may describe the content item 111 at a high level, but may lack other details of the content item 111 such as the style or particular arrangement details. For example, the user prompt 101 may range from a request broadly describing the content item 111, such as “please generate a slide depicting the life cycle of a chicken” to more specific requests such as “please generate a slide depicting the life cycle of a chicken as a circular diagram in a simple artistic style, using sketch-like drawings.”

The computing system 100 can generate element description data 103. The element description data 103 can include a listing of descriptors or descriptions (e.g., plain text descriptions) of one or more elements 105 of the content item 111. For example, the element description data 103 can describe each element 105 of the content item 111 in a computer-interpretable format, such as plain text, and/or a computer-interpretable data structure. The element description data 103 can conform to a schema, such as, for example, a JavaScript Object Notation (JSON) schema, an Extended Markup Language (XML) schema, a Comma-Separated Value (CSV) schema, an INI schema, or other suitable schema. The schema can be indicative of syntax and validity of data of the element description data 103. Additionally or alternatively, the schema can be or can include an API call format. For instance, the element description data 103 can be a “skeleton” representation of the elements 105 of the content item 111, such as text data descriptive of images and captions to be displayed on a slide or graphic.

One example element description data 103 can be a JSON file or other similar list having delineated or ordered values. The values can respectively correspond to the elements 105 of the content item 111 and/or can describe the elements 105. For example, one element description data 103 may include delineated values descriptive of four images representative of the life cycle of a butterfly; e.g., describing in text data the depiction of a butterfly egg on a leaf corresponding to an “egg” stage, a caterpillar on a leaf corresponding to a “larva” stage, a chrysalis hanging from a leaf corresponding to a “pupa” stage, and a butterfly in the air corresponding to an “adult” stage. Other values in the element description data 103 may be descriptive of, for example, titles, captions, arrangements, etc. respective to each stage. The elements 105 can be any suitable elements that may be generated by a computing system (e.g., the computing system 100). As examples, the elements 105 can be or can include image elements or visual elements, graphics, audio elements (e.g., sound effects, music, background audio, etc.), text elements, and/or other suitable elements that may be included in content item 111.

Based on the element description data 103, the computing system 100 can generate the one or more elements 105 of the content item 111. For instance, the computing system 100 can produce, for each element 105 described by the element description data 103, a data item that matches the description of the element 105 in the element description data 103. As an example, if the element description data 103 describes an element that is “an image depicting a butterfly egg on a leaf,” the computing system can generate an image depicting a butterfly egg on a leaf as the element 105. That element 105 can eventually be combined with other elements 105 to produce the content item 111 such that the content item 111 is thematically and stylistically consistent while also conforming to a structure associated with the content item 111, as described further herein.

According to example aspects of the present disclosure, the content item 111 can be generated responsive to the user prompt 101 with elements 105 that conform to a structure or format (e.g., file format) associated with the content item 111. The structure may be user-specified or program-specified. For example, the user may select, include in the user prompt 101, or otherwise indicate a particular structure or format that the user wishes for the content item 111 to conform to. As another example, the structure may be specified based on the type of content item 111 and/or a larger program or creative tool used to generate the content item 111. For example, if the user prompt 101 is received from a slide show creation program, such as a program configured to create and edit slide show files (e.g., .ppt files, .odp files, etc.), the content item 111 can be generated to conform to the slide show file format in use by the slide show creation program. As yet another example, in some implementations, the computing system 100 can infer (e.g., by the first machine-learned model) or determine (e.g., by an association between types of content item and structures or formats) which structure to be used based on the user prompt 101. By conforming to a structure or format, the content item 111 can be modified by the user post-generation such that the user can, for example, replace or regenerate only some portion of the content item 111 without entirely discarding the content item 111.

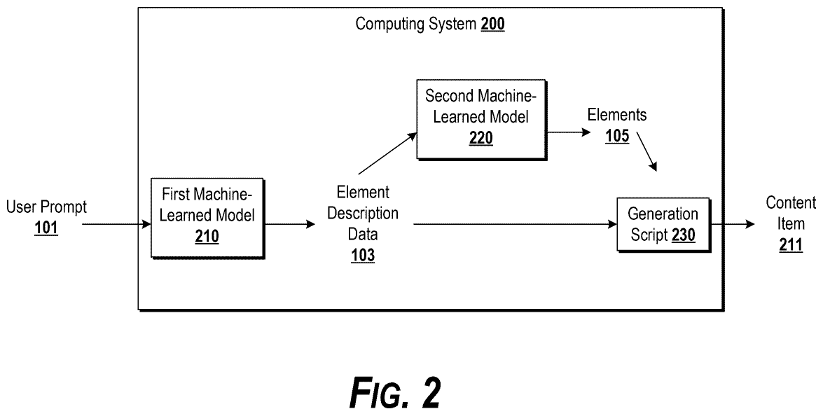

FIG. 2 is a block diagram of an example computing system 200 for structure-conforming generation of a content item 211 according to example implementations of the present disclosure. The computing system 200 can include some elements described with reference to the computing system 100 of FIG. 1. For instance, components of the computing system 200 including like reference numbers to components of the computing system 100 can share described aspects of the components of the computing system 100, except where otherwise indicated.

The computing system 200 can receive a user prompt 101 and generate a content item 211 responsive to the user prompt 101. In particular, the content item 211 can be generated by or using one or more machine-learned models, including a first machine-learned model 210 and a second machine-learned model 220. Alternatively, in some implementations, a single machine-learned model (e.g., a general-purpose machine-learned model) can perform some or all of the functionality described herein with respect to the first machine-learned model 210 and the second machine-learned model 220. In particular, although the computing system 200 depicts two machine-learned models 210 and 220, more or fewer machine-learned models can be employed by computing systems without departing from the present disclosure.

Generating the element description data 103 can be performed using the first machine-learned model 210. For instance, the user prompt 101 can be provided as input to the first machine-learned model 210. In some implementations, the first machine-learned model 210 can be a model configured to interpret text data, such as a language model (e.g., a large language model). In response to the user prompt 101, the first machine-learned model 210 can output the element description data 103. In some implementations, the first machine-learned model 210 can be instructed to condition its outputs to conform to a schema prior to providing it with the user prompt 101. The element description data 103 can then be provided to a second machine-learned model 220, such as an image generation model. The image generation model may be, for example, a diffusion model or an autoregressive model. In response to the element description data 103, the second machine-learned model 220 can generate the elements 105 of the content item 211 as specified by the element description data 103. Based on the element description data 103, the second machine-learned model 220 can produce elements 105 matching the descriptions of the elements 105 of the content item 211.

If details of the content item 211 are not specified by the user prompt 101, the computing system 200 may infer some or all of the unspecified details to generate an interesting content item 211. For instance, the use of machine-learned models as described herein can provide for inferring unspecified details based on the context of the user prompt 101, even if that context is minimal. For example, if a user prompt 101 instructs the computing system 200 to generate a slide depicting a life cycle of a chicken without additional information, the computing system may infer thematic elements associated with farms, poultry, birds, and so on based on the learned associations of the machine-learned models between tokens such as “chicken” and “farm,” “wheat,” “checkered,” “plaid,” and so on, based on the training data provided to the computing system 200. The slide that is generated may therefore include these stylistic elements, even without requiring explicit input from the user. For example, the generated slide may include a background depicting a barn or chicken coop, or stylistic elements may resemble checkered fabric or plaid, wrought-iron tools, picket fences, or other graphical elements typically associated with the “chicken” token and other nearby tokens. For instance, in one example, the first machine-learned model 210 (e.g., a language model) may generate or otherwise utilize tokens that are proximate to the “chicken” token on a spatial plot of learned token associations, such as, for example, “farm,” “wheat,” “corn,” “checkered,” and similar tokens. The element description data 103 that is generated may therefore include some or all of these tokens. When the element description data 103 is passed to a second machine-learned model 220 (e.g., an image generation model), the second machine-learned model 220 may generate elements 105 that are at least partially responsive to these proximate tokens. For example, an image generation model may generate images that depict wheat, corn, checkered fabric, and so on. These images can be combined according to the element description data 103 to produce a thematically-consistent slide with a theme that may generally be described as “chicken ranching” or “farm life” or other similar agrarian theme. As another example, if a user prompt 101 instructs the computing system to generate a slide depicting a life cycle of a butterfly, again without any additional information, the computing system may infer thematic elements associated with flowers, trees, forests, nature and other items that are typically associated with the “butterfly” token. In this manner, the user can receive aesthetically pleasing and thematically consistent content items even in the case of minimal interaction from the user.

The elements 105 and the element description data 103 can be used to generate the content item 211. For instance, the computing system 200 can generate the content item 211 by implementing a generation script 230. For example, the generation script 230 can be implemented to cause the computing system 200 to parse, assemble, and/or arrange the elements 105 and relevant portions of the element description data 103 into a structure-conforming content item 211. For example, the computing system 200 can perform a “piecewise” or “stepwise” generation of the content item 200, where the elements 105 are generated as independent data structures and combined according to the structure of the content item 211 (e.g., based on the generation script 230) to produce the content item 211. For example, a structure may specify that images included in the content item 211 are formatted according to a given data structure that includes the image data itself and/or metadata such as position of the image within the content item. The computing system 200 can input the generated element 105 into the data structure along with associated metadata and other information required by the structure. As another example, if the content item 211 includes text data, the text data can be generated as an element 105 or pulled from a respective field in the element description data 103 (e.g., a title field or caption field). The text data can be stored according to a respective data structure within the structure, such as a data structure specifying the format for the text data and formatting for the text data, such as text size, text modifiers, font, and so on.

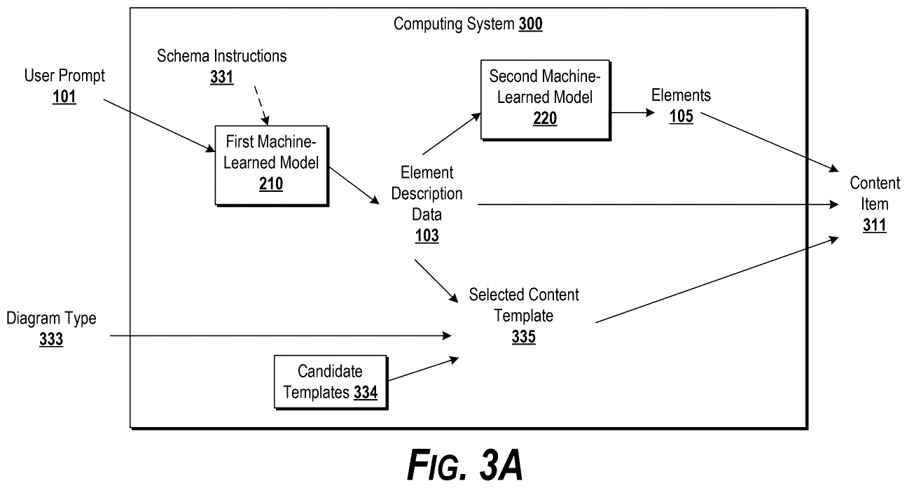

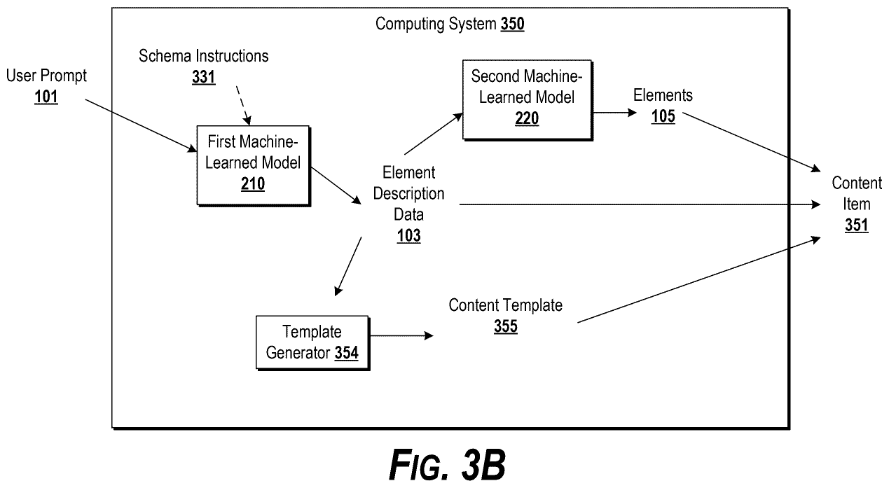

FIG. 3A is a block diagram of an example computing system 300 for structure-conforming generation of a content item 311 according to example implementations of the present disclosure. The computing system 300 can include some elements described with reference to the computing system(s) 100 of FIGS. 1 and/or 200 of FIG. 2. For instance, components of the computing system 300 including like reference numbers to components of the computing system(s) 100, 200 can share described aspects of the components of the computing system 100, 200, except where otherwise indicated.

The computing system 300 can receive a user prompt 101 and generate a content item 311 responsive to the user prompt 101. In particular, the computing system 300 can generate the element description data 103 based on a schema. For instance, the element description data 103 can conform to the schema. For example, the schema can be a JavaScript Object Notation (JSON) schema, an Extended Markup Language (XML) schema, a Comma-Separated Value (CSV) schema, an INI schema, or other suitable schema. The schema can be indicative of syntax and validity of data of the element description data 103. Additionally or alternatively, the schema can be or can include an API call format. For instance, the element description data 103 can be a “skeleton” representation of the elements 105 of the content item 311, such as text data descriptive of images and captions to be displayed on a slide or graphic.

The computing system 300 can provide schema instructions 331 to the first machine-learned model 210 to cause the first machine-learned model 210 to produce outputs (e.g., the element description data 103) conforming to the schema. In some implementations, the schema can be provided or specified by the user (e.g., the user providing the user prompt 101. For example, the schema instructions 331 can be provided by the user. Additionally or alternatively, in some implementations, the schema can be stored on the computing system 300. For example, the computing system 300 may provide the schema instructions 331 to the first machine-learned model without action by the user. Additionally or alternatively, in some implementations, the schema may not be stored locally. For example, the first machine-learned model 210 may be pretrained to generate an output (e.g., the element description data 103) conforming to the schema.

Additionally or alternatively, the computing system 300 can generate the content item 311 to fit a selected content template 335 based on a diagram type 333 of a diagram that is or is included in the content item 311. For instance, the computing system 300 can obtain a diagram type 333. The diagram type 333 can, in some implementations, be specified by the user (e.g., via the user prompt 101). Additionally or alternatively, the computing system 300 (e.g., by the first machine-learned model 210) can determine the diagram type 333 such that the diagram type 333 represents the content displayed in the diagram. The diagram type, for example, can relate to the manner in which the elements of the diagram are displayed or positioned. As one example, the diagram type 333 may specify a “cycle” diagram generally depicted as multiple stages positioned in a circular or ovular fashion. For instance, the cycle diagram may be useful for depicting life cycles, weather patterns, iterative steps, and other phenomena that are cyclical in nature. As another example, the diagram type 333 may specify an “ordered” diagram such as one or more stages positioned in a linear fashion. An ordered diagram may be useful for depicting linear processes, flowcharts, and so on. As yet another example, the diagram type 333 may specify an “unordered” diagram such as one or more stages positioned in a seemingly irregular arrangement.

The computing system 300 can select a selected content template 335 of a plurality of candidate 334 templates based on the diagram type 333 and the element description data 103. For instance, based on the diagram type 333 and/or the number of elements 105 in the content item 311 or diagram, the computing system 300 can select the selected content template 335 for the content item 311 that is appropriate for the diagram and the content item 311. Additionally or alternatively, the computing system 300 can select a selected content template 335 based on a number of elements 105 to be displayed in the diagram. For instance, in some implementations, the element description data 103 can include a number of the one or more elements 105. The element description data 103 can include the number of elements implicitly based on the number of fields and/or explicitly based on a value of a dedicated field describing the number of elements 105. The selected content template 335 can be selected based on the number of the one or more elements 105. For instance, if the element description data 103 describes five elements 105 in a diagram, the computing system 300 can select a selected content template 335 having five placeholder elements.

The computing system 300 can then generate the content item 311 according to the associated structure of the content item 311 and based on the element description data 103 and the one or more elements, and further based on the selected content template 335. For example, the computing system 300 can position and/or format the elements 105 within the content item 311 based on the selected content template 335. In some implementations, the selected content template 335 can be a structural template; for instance, it can be descriptive of one or more display aspects of one or more placeholder elements corresponding to the one or more elements 105 of the content item 311. The display aspects can be, for example, position, format, color, style, size, font, border, effect (e.g., shading, transition effects, etc.), and other suitable aspects or metadata relative to an element 105. For instance, the selected content template 335 can be data descriptive of positional relationships, sizes, formatting, color, and so on for elements of the content item 311 and/or additional (e.g., graphical) elements to be included in the content item 311, without necessarily being dependent on the content of the elements 105 themselves. As one example, the selected content template 335 can describe positions of five images in a cyclical diagram in a center of a slide, but may not describe the five images themselves. As another example, the selected content template 335 may describe that 12 point red Times New Roman font is located at a given position in the infographic, but may not describe the characters of the text.

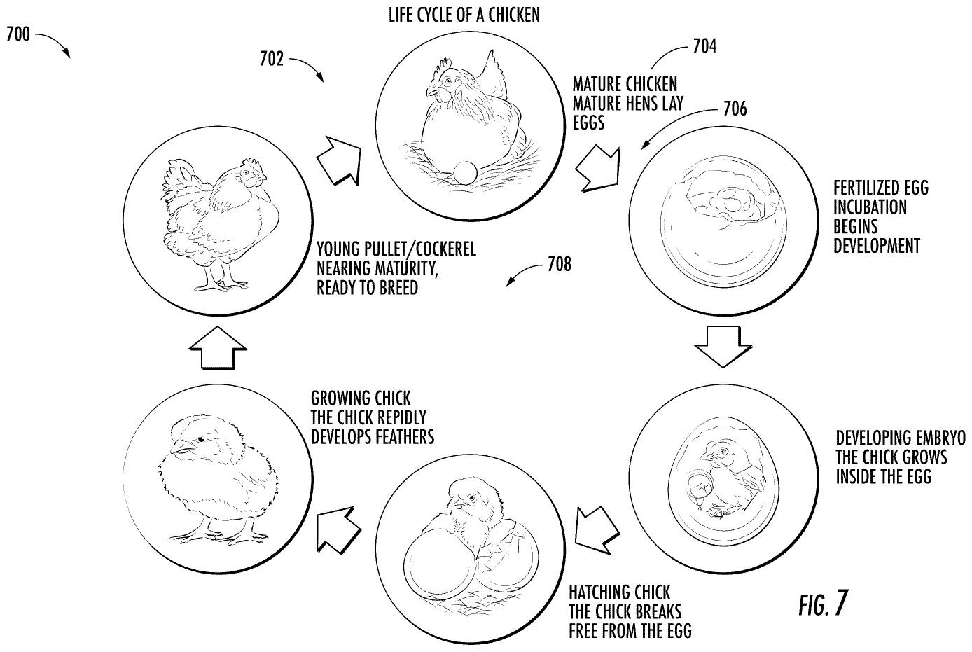

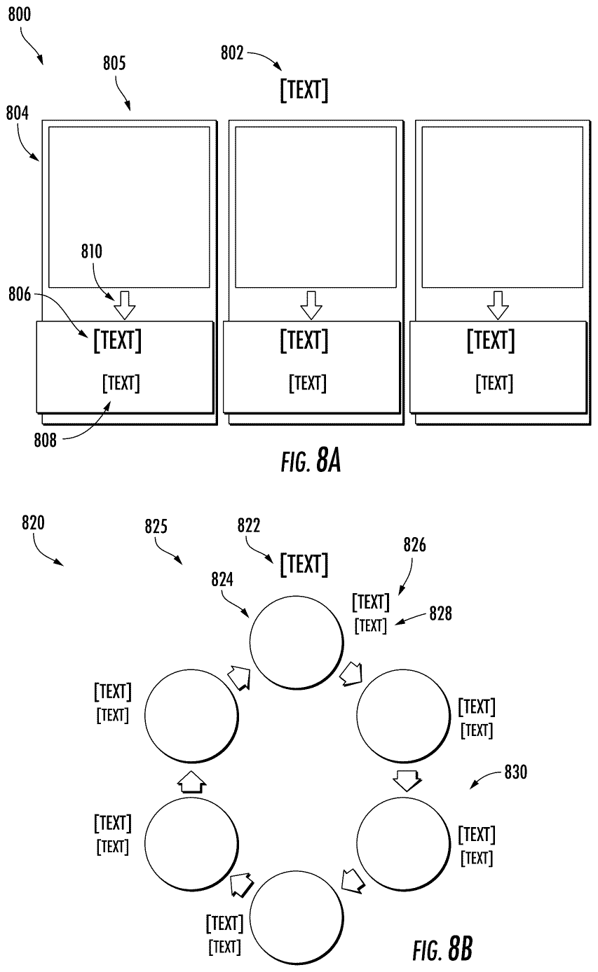

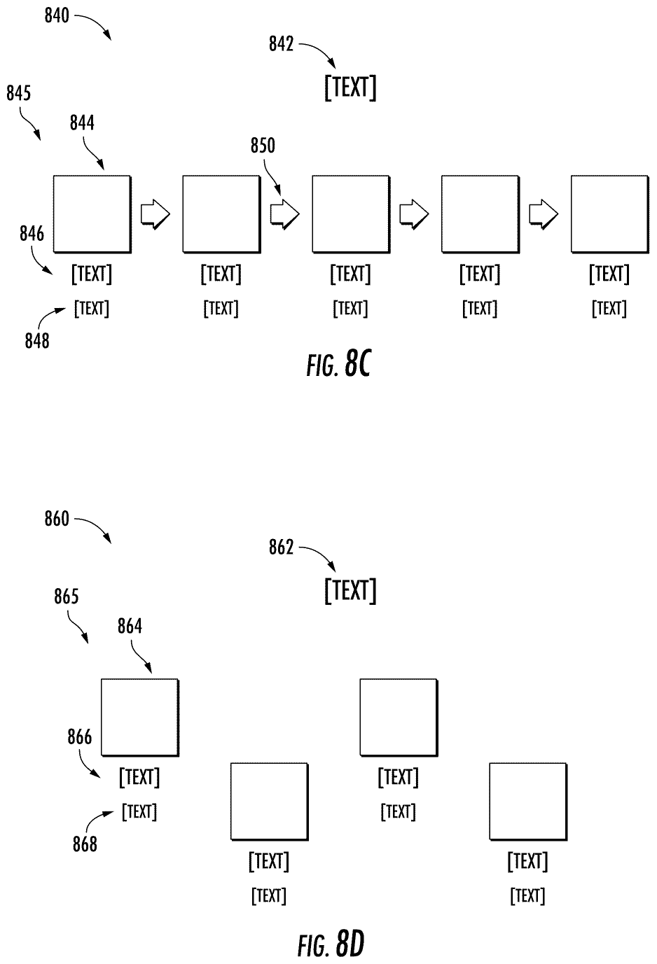

The selected content template 335 may be, for example, a template slide of a slideshow editor. The selected content template 335 can be responsive to the display requirements of the element description data 103. For instance, if the element description data 103 contains four elements and the type of diagram is a cycle diagram, the selected content template 335 may describe four element positions arranged in a cycle. Additionally or alternatively, the selected content template 335 may include arrows or other graphics depicting a cyclical relationship. Some example content templates are depicted in FIGS. 8A-8D .

FIG. 3B is a block diagram of an example computing system 350 for structure-conforming generation of a content item 351 according to example implementations of the present disclosure. Similar to the computing system 300 of FIG. 3A, the computing system 350 can generate the content item 351 responsive to a content template 355. In the example of FIG. 3B, however, the content template 355 can be procedurally generated by a template generator 354 to “fit” the elements 105 based on the element description data 103. For instance, the computing system 350 can determine an arrangement of elements specified by the element description data 103. The computing system 350 (e.g., the template generator 354) can then generate the content template based on the arrangement of elements specified by the element description data. For example, as described further herein, the element description data 103 can convey information relating to positional, conceptual, and/or other relationships between the elements 105. The template generator 104 can produce the content template 355 such that it includes placeholder elements corresponding to the elements 105. Additionally and/or alternatively, in some implementations, the content template can be descriptive of one or more display aspects of one or more placeholder elements corresponding to the one or more elements of the content item. The placeholder elements may be, for example, a partial element having some formatting, positional, or other display aspects that are shared with the elements 105. However, the placeholder elements may not include the content of the elements 105. Generating the content item 351 can include applying the display aspects of the one or more placeholder elements to the one or more elements 105 of the content item 351. For example, a placeholder element may be a slot or default item that is ultimately replaced with an element 105, while maintaining the position and/or formatting of the placeholder element, when generating the content item 351. The display aspects can be, for example, position, format, color, style, size, font, border, effect, or other suitable display aspect.

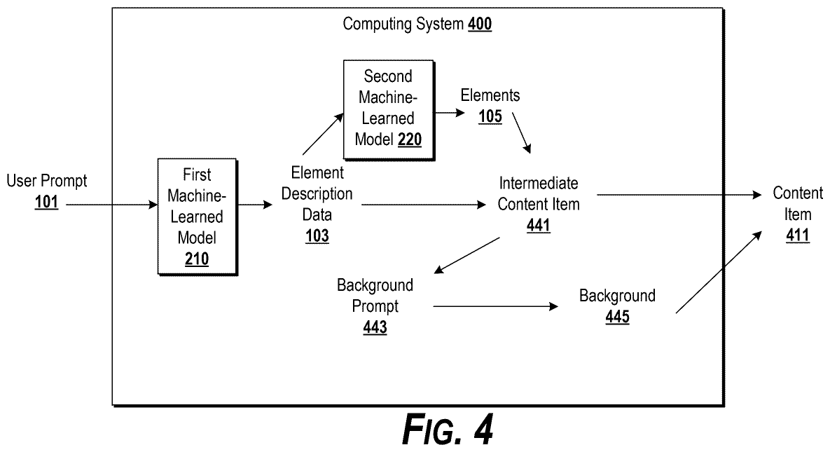

FIG. 4 is a block diagram of an example computing system 400 for structure-conforming generation of a content item 411 according to example implementations of the present disclosure. The computing system 400 can include some elements described with reference to the computing system(s) 100 of FIGS. 1, 200 of FIG. 2, and/or 300 of FIG. 3. For instance, components of the computing system 400 including like reference numbers to components of the computing system(s) 100, 200, 300 can share described aspects of the components of the computing system 100, 200, 300, except where otherwise indicated.

In particular, the computing system 400 can generate a background 445 for the content item 411 based on the elements 105 of the content item 411. For example, the background can be thematically consistent with the elements 105 and the other portions of the content item 411. In some implementations, the background 445 can be generated along with the other elements 105 of the content item 411. Additionally or alternatively, in some implementations, the background 445 can be generated by a background generation system subsequent to the other elements 105. In particular, the computing system 400 can generate an intermediate content item 441 based on the element description data 103 and the one or more elements 105. The intermediate content item 441 can have a default background. For example, the intermediate content item 441 may have a solid black or white background, a transparent background, or other background that is a default for a creation tool. In addition to or alternatively to having a default background, the intermediate content item 441 may not have any background. The intermediate content item can be similar to, for example, the content items 111, 211, and 311 of FIGS. 1-3, in that the intermediate content item can be created according to a structure, but may not have a separately generated background.

The computing system 400 can generate a background prompt 443 descriptive of a background 445 to be generated for the content item 411. For instance, the computing system 400 can generate a background prompt 443 based on the element description data 103 and/or the elements 105 or, additionally or alternatively, based on the intermediate content item 441 that lacks a customized background. For example, the background prompt 443 can describe the background 445 to be generated in plain language (e.g., text data). The background prompt 443 can be similar to a descriptor of the elements 105 in the element description data 103.

The computing system 400 can generate the background 445 based on the background prompt 443. For example, the computing system 400 can generate a background 445 that is responsive to the background prompt 443. The background 445 can be, for example, an image, gradient, or other suitable background. Generating the content item 411 according to the associated structure of the content item 411 and based on the element description data 103 and the one or more elements 105 can further be based on the background 445. For example, the background 445 can be combined with the intermediate content item 441 (e.g., in a background field of the structure) to produce the final content item 411. As one example, a generation script (e.g., similar to the generation script 230 of FIG. 2) can be used to combine the background with the other elements 105 of the intermediate content item 441 to produce the content item 411. For example, in some implementations, the background 445, the intermediate content item 441, the elements 105, and/or the element description data 103 can be provided to the generation script configured to combine the items to generate the content item 411.

In some implementations, one or more machine-learned models can be used to generate the background 445. As one example, the first machine-learned model 210 (e.g., the model used to generate the element description data 103) can generate the background prompt 443 based on the intermediate content item 441 such that the background prompt 443 describes thematic or stylistic elements that are consistent with similar thematic or stylistic elements of the elements 105. The second machine-learned model 220 (e.g., the model used to generate the elements 105) can generate the background 445 based on the background prompt 443.

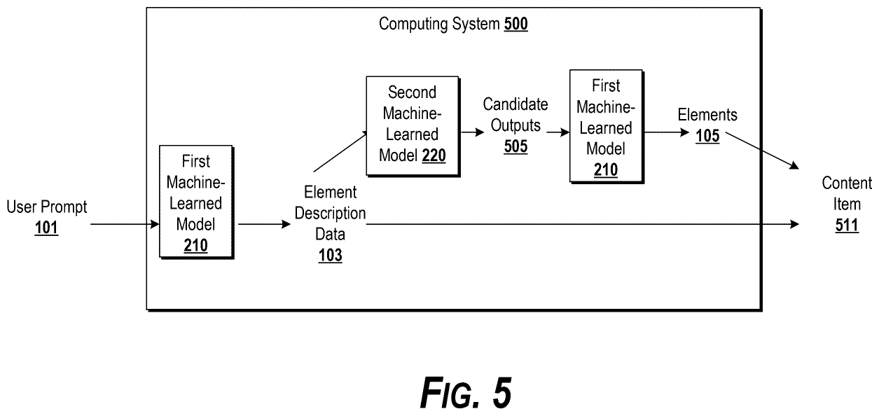

FIG. 5 is a block diagram of an example computing system 500 for structure-conforming generation of a content item 511 according to example implementations of the present disclosure. The computing system 500 can include some elements described with reference to the computing system(s) 100 of FIGS. 1, 200 of FIGS. 2, 300 of FIG. 3, and/or 400 of FIG. 4. For instance, components of the computing system 400 including like reference numbers to components of the computing system(s) 100, 200, 300, 400 can share described aspects of the components of the computing system 100, 200, 300, 400, except where otherwise indicated.

In particular, the computing system 500 can be configured to select the elements 105 from several potential or candidate outputs 505 of the second machine-learned model 220. For example, the second machine-learned model 220 can be instructed to produce a plurality of candidate outputs 505, and a desired output (e.g., the elements 105) can be selected from the plurality of candidate outputs 505. The computing system can obtain a plurality of candidate outputs 505 of the second machine-learned model 220. The plurality of candidate outputs 505 can be responsive to the descriptors of the one or more elements 105 in the element description data 103. For example, each of the candidate outputs 505 may include a plurality of candidate elements that generally correspond to the elements 105 of the element description data 103, but may be generated by different seeding or other inputs such that the candidate elements corresponding to a given desired element are not necessarily identical.

The computing system can use the first machine-learned model 210 as an adversarial model to select the one or more elements 105 of the content item 511 from the plurality of candidate outputs 505. For instance, the computing system can provide the plurality of candidate outputs 505 of the second machine-learned model 220 to the first machine-learned model 210. In addition to the candidate outputs 505 themselves, in some implementations, the first machine-learned model 210 may additionally be provided with instructions to cause the model to interpret the elements 105 in an adversarial manner. For example, the first machine-learned model 210 may be prompted with a selection prompt based on the user prompt or the element description data 103. As one example, the selection prompt may be a phrase such as “Which of these images is best at showing <element>” where “<element>” is or is based on the descriptor of an element in the element description data 103. Although FIG. 5 depicts using the first machine-learned model 210 as an adversarial model, in some implementations, another adversarial model (e.g., a third machine-learned model) can be used in place of the first machine-learned model 210.

The computing system 500 can select (e.g., by the first machine-learned model 210) the one or more elements 105 to be included in the content item 511 from the plurality of candidate outputs 505. The computing system 500 may select an element that scores highly relative to the descriptor of the element from the candidate outputs 505. For example, if the first machine-learned model 210 is prompted with an instruction such as “which of these images is best at showing” some given aspect, the first machine-learned model 210 may predict or assign rankings to each candidate element in the candidate outputs 505 based on the given aspect and select the highest-ranking candidate element (or some other high-ranking candidate element). In some cases, the elements 105 may be selected from among multiple candidate outputs 505. For example, a first element may be selected from a first candidate output, and a second element can be selected from a second candidate output. Furthermore, in some implementations, the candidate elements may be grouped based on which element in the element description data 103 they correspond to, and a candidate element from each group may be selected. For example, in the “life cycle of a chicken” example, each stage of the life cycle can be a group, such as an “egg” group where each candidate element is generated in response to the description of the “egg” life cycle stage in the element description data 103.

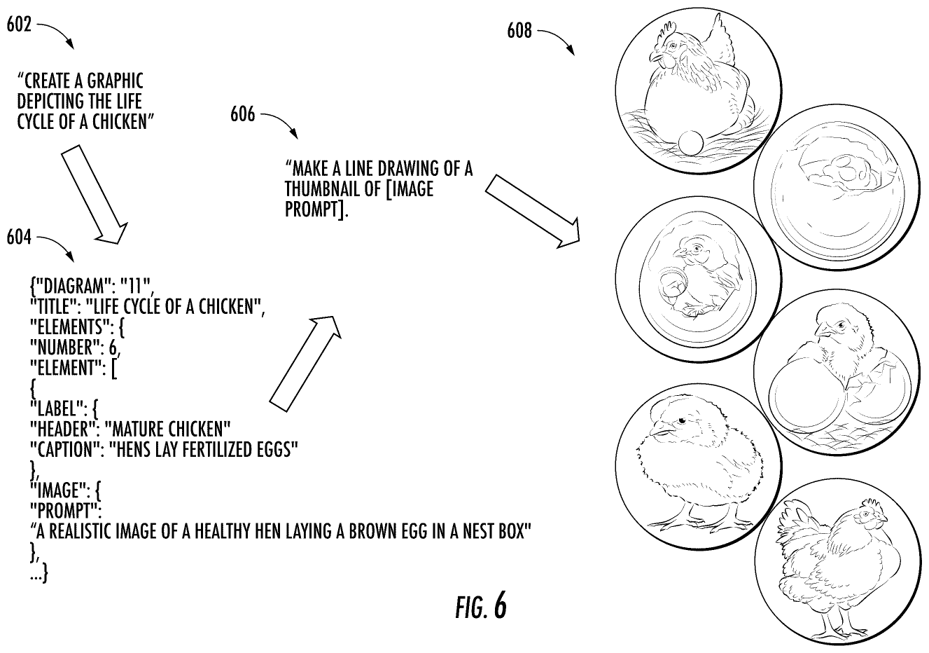

FIG. 6 is a flow chart diagram illustrating example data items that can be used and/or generated according to example implementations of the present disclosure. In particular, FIG. 6 includes examples of a user prompt 602, an excerpt of element description data 604, an example of an element generation prompt 606 that may be provided to a machine-learned model, such as a second machine-learned model, and examples of elements 608 that may be generated based on descriptors in the element description data 604.

For instance, a user may input the user prompt 602 into a text field or other input field configured to provide the user prompt 602 to a computing system configured to generate a content item responsive to the user prompt 602. The user prompt 602, as illustrated, is generally simple. For instance, the user prompt 602 instructs the system to “create a graphic depicting the life cycle of a chicken.” The user prompt 602 is noticeably silent as to stylistic components of the graphic. According to example aspects of the present disclosure, the system can generate structure-conforming content items that can be editable by the user after the content items are generated. This can provide for the user to “fill in” elements that the user wishes to include after the content item is generated, regenerate existing elements that the user wishes to modify, and/or manually replace elements that the user does not wish to regenerate. Additionally or alternatively, this can provide that the computing system can infer what stylistic choices the user would prefer, without mandating that the user is locked to those stylistic choices if the user wishes to change them later.

The computing system can generate the element description data 604 in response to the user prompt 602. As illustrated in FIG. 6, the element description data 604 includes significantly more detail than the user prompt 602. A majority of this detail can be generated by the computing system (e.g., by a first machine-learned model). For instance, the computing system has included a “diagram” field in the element description data 604, indicating that the “graphic depicting the life cycle of a chicken” will include a diagram. Additionally, the computing system has included a “title” field in the element description data 604, which titles the graphic “Life Cycle of a Chicken.” Furthermore, the computing system has recognized that there will be six stages in the life cycle of a chicken, and has included this in the “number” field of the element description data 604. Finally, the element description data 604 includes an “element” field, which includes a delineated list of descriptors about each element 608. As illustrated, the first element includes a “label” field which further specifies a “header” and a “caption” field. The header field—in this example, “Mature Chicken”—describes the stage at a high level, and the caption field—here “hens lay fertilized eggs”—describes the stage in more detail. Of course, it should be understood that the header field and the caption field are merely exemplary, and different element description datas generated by the systems and methods described herein may include any of a variety of fields, including but certainly not limited to those described herein. For conciseness, only the descriptor of the first element (the “mature chicken” stage) is depicted in FIG. 6. It should be understood that the element description data 604 can include additional descriptors corresponding to each of the elements 608.

FIG. 6 depicts one example element description data 604 according to some implementations of the present disclosure for the purposes of illustration. It should be understood that, in some implementations, element description data can be represented in another suitable format. For instance, in some implementations, the element description data can be a skeleton representation of a diagram having a plurality of nodes and relationships of the nodes defined by a plurality of edges between the nodes. Additionally and/or alternatively, in some implementations, the element description data can be code, data, or other computer-interpretable information (e.g., a data structure) that can provide for a computing system to produce a diagram based on the element description data.

These text fields, such as the title field, the header field, and the caption field, may be input directly into a content template to produce the graphic. For instance, the graphic may include the verbatim text “Life Cycle of a Chicken” in a respective title field of the content template used to generate the graphic. In addition to these text fields, however, the element description data 604 defines an “image” field with a prompt describing an image to be generated for that stage. For instance, the image matching this “Mature Chicken” stage is described as “a realistic image of a healthy hen laying a brown egg in a nest box.” It will be appreciated that the computing system was able to infer the stylistic details about how this stage will be represented without explicitly querying the user, for example based on the use of a first machine-learned model.

To create the content item, the computing system can generate the images described in the “image” fields of the descriptors of the respective stages. To generate the images, the computing system can use a machine-learned model (e.g., the second machine-learned model). The computing system can provide the descriptors to the machine-learned model. In some implementations, the descriptors are provided as-is (e.g., directly from the element description data 604). In some implementations, however, the descriptors can be combined with additional text, as in the example of FIG. 6, to produce the generation prompt 606.

The generation prompt 606 includes additional text that instructs the model how to generate the elements 608. For example, the generation prompt 606 reads “Make a line drawing of a thumbnail of [image prompt]. Ignore all colors, use black ink on white background only. Do not add any text.” where [image prompt] would be replaced by a respective descriptor from the “prompt” field of the element description data 604. For example, for the “Mature Chicken” stage illustrated in FIG. 6 and to produce the image of a mature hen laying an egg in the elements 608, the model could be prompted with “Make a line drawing of a realistic image of a healthy hen laying a brown egg in a nest box. Ignore all colors, use black ink on white background only. Do not add any text.” It should be appreciated that some of the additional text in the generation prompt 606, such as “line drawing” and “do not add any text” reflect stylistic inferences made by the computing system to produce a stylistically coherent and consistent graphic.

The generation prompt(s) 606 can be provided as input to the (e.g., second) machine-learned model. The model can produce the elements 608 in response to the generation prompt. For example, the generation prompt using the “prompt” field depicted in FIG. 6 could be input to the model to produce the first element 608, which is an image depicting a mature hen laying an egg. Other image prompts in the element description data can be used with the generation prompt 606 to produce the other elements 608. For example, to produce the element 608 corresponding to the “Fertilized Egg” stage, the image prompt may be text such as “close-up of a fertilized chicken egg, subtly showing early embryo development inside.” The elements 608 can be combined (e.g., with the “label” fields from the element description data 604, in some implementations) to produce a structure-conforming content item.

FIG. 7 is an example content item 700 that can be generated according to example implementations of the present disclosure. For instance, the content item 700 can be generated by combining the elements 608 and/or the element description data 604 of FIG. 6 in a cycle diagram. For instance, the content item 700 includes a plurality of stages in a cycle. Each stage includes an image 702, labels 704 corresponding to the image, and a graphical element 706 illustrating the next stage. For example, the first stage depicted at the top of the content item 700 depicts the mature hen element 608 from FIG. 6 as the image 702. Furthermore, the labels 704 are populated with text from the element description data 604 of FIG. 6, namely the “header” field and the “caption” field for each stage. The graphical elements 706 are not necessarily generated by the computing system in all instances. In some implementations, for example, the graphical elements 706 may be included in a content template used to generate the content item 700. Finally, the content item 700 includes a title 708 that is populated with text from the “title” field of the element description data 604 of FIG. 6.

FIG. 8A-8D are visualizations of example content templates according to example implementations of the present disclosure. In particular, FIG. 8A is a visualization of a first content template 800 according to example implementations of the present disclosure. For example, FIG. 8A can be representative of how a content item generated according to the first content template 800 would look if using placeholder values for each field. The content template 800 includes a title field 802. The title field 802 can be configured to receive and display a title of a content item according to the content template 800. For example, element description data may include a “title” field, and the value in that title field may be input to the title field 802 of the content template 800. Additionally or alternatively, the content template 800 can include groups 805, each having an image field 804, a header field 806, and a caption field 808. The image field 804, for example, may be configured to receive and display elements (e.g., the generated elements as described herein) that include image data. The header field 806 and caption field 808 may be configured to receive and display text data descriptive of headers and captions, respectively, associated with the image field 804. For example, the header and/or caption may, in some implementations, be generated as an element. Additionally or alternatively, in some implementations, the header and/or caption may be included in the element description data. It should be understood that the content template 800 is merely exemplary, and more or fewer fields may be included in a content template without departing from the present disclosure.

Furthermore, the content template 800 includes graphical elements 810. The graphical elements 810 may be included directly in the content template 800 (e.g., they may not be dependent on data in element description data or the generated elements). The graphical elements 810 are depicted as arrows, but any other suitable graphical elements can be included in a content template according to the present disclosure. It should be understood that the content template 800 is merely exemplary, and more or fewer fields may be included in a content template without departing from the present disclosure.

The content template 800 may be, for example, an “ordered” template. As illustrated in FIG. 8A, each of the groups 805 having the image field 804, the header field 806, and the caption field 808 share a relatively similar importance within the content template 800 as a whole. For example, each of the groupings 805 are aligned in a horizontal direction and/or evenly spaced in a vertical direction. Additionally or alternatively, the title field 802 is centered within the content template 800. The content template 800, or a similar content template, may therefore be utilized by the systems and methods described herein when generating content items to convey information that reflects a similarly themed ordering. Additionally or alternatively, the content template 800 includes space for three groups 805, so the content template 800 may be selected if the element description data includes three elements.

FIG. 8B is a visualization of a second content template 820 according to example implementations of the present disclosure. For example, FIG. 8B can be representative of how a content item generated according to the second content template 820 would look if using placeholder values for each field. The content template 820 includes a title field 822. The title field 822 can be configured to receive and display a title of a content item according to the content template 820. For example, element description data may include a “title” field, and the value in that title field may be input to the title field 822 of the content template 820. Additionally or alternatively, the content template 820 can include groups 825, each having an image field 824, a header field 826, and a caption field 828. The image field 824, for example, may be configured to receive and display elements (e.g., the generated elements as described herein) that include image data. The header field 826 and caption field 828 may be configured to receive and display text data descriptive of headers and captions, respectively, associated with the image field 824. For example, the header and/or caption may, in some implementations, be generated as an element. Additionally or alternatively, in some implementations, the header and/or caption may be included in the element description data.

Furthermore, the content template 820 includes graphical elements 830. The graphical elements 830 may be included directly in the content template 820 (e.g., they may not be dependent on data in element description data or the generated elements). The graphical elements 830 are depicted as arrows, but any other suitable graphical elements can be included in a content template according to the present disclosure. It should be understood that the content template 820 is merely exemplary, and more or fewer fields may be included in a content template without departing from the present disclosure.

The content template 820 may be, for example, a “cycle” template. As illustrated in FIG. 8B, each of the groups 825 having the image field 824, the header field 826, and the caption field 828 are spaced in a cyclical relationship around the center of the content template 820. For example, each of the groupings 825 are relatively equal in size and “flow” from one group to the next through the graphical elements 830. Additionally or alternatively, the title field 822 is centered within the content template 820. The content template 820, or a similar content template, may therefore be utilized by the systems and methods described herein when generating content items to convey information that reflects a similarly themed ordering. Additionally or alternatively, the content template 820 includes space for five groups 825, so the content template 820 may be selected if the element description data includes five elements.

FIG. 8C is a visualization of a first content template 840 according to example implementations of the present disclosure. For example, FIG. 8C can be representative of how a content item generated according to the first content template 840 would look if using placeholder values for each field. The content template 840 includes a title field 842. The title field 842 can be configured to receive and display a title of a content item according to the content template 840. For example, element description data may include a “title” field, and the value in that title field may be input to the title field 842 of the content template 840. Additionally or alternatively, the content template 840 can include groups 845, each having an image field 844, a header field 846, and a caption field 848. The image field 844, for example, may be configured to receive and display elements (e.g., the generated elements as described herein) that include image data. The header field 846 and caption field 848 may be configured to receive and display text data descriptive of headers and captions, respectively, associated with the image field 844. For example, the header and/or caption may, in some implementations, be generated as an element. Additionally or alternatively, in some implementations, the header and/or caption may be included in the element description data. It should be understood that the content template 840 is merely exemplary, and more or fewer fields may be included in a content template without departing from the present disclosure.

Furthermore, the content template 840 includes graphical elements 850. The graphical elements 850 may be included directly in the content template 840 (e.g., they may not be dependent on data in element description data or the generated elements). The graphical elements 850 are depicted as arrows, but any other suitable graphical elements can be included in a content template according to the present disclosure. It should be understood that the content template 840 is merely exemplary, and more or fewer fields may be included in a content template without departing from the present disclosure.

The content template 840 may be, for example, an “ordered flow” template. As illustrated in FIG. 8C, each of the groups 845 having the image field 844, the header field 846, and the caption field 848 share a relatively similar importance within the content template 840 as a whole. For example, each of the groupings 845 are aligned in a horizontal direction and/or evenly spaced in a vertical direction. Additionally or alternatively, the title field 842 is centered within the content template 840. Furthermore, the graphical elements 850 depict a “flow” from each group 845 to the next. The content template 840, or a similar content template, may therefore be utilized by the systems and methods described herein when generating content items to convey information that reflects a similarly themed ordering. Additionally or alternatively, the content template 840 includes space for five groups 845, so the content template 840 may be selected if the element description data includes five elements.

FIG. 8D is a visualization of a first content template 860 according to example implementations of the present disclosure. For example, FIG. 8D can be representative of how a content item generated according to the first content template 860 would look if using placeholder values for each field. The content template 860 includes a title field 862. The title field 862 can be configured to receive and display a title of a content item according to the content template 860. For example, element description data may include a “title” field, and the value in that title field may be input to the title field 862 of the content template 860. Additionally or alternatively, the content template 860 can include groups 865, each having an image field 864, a header field 866, and a caption field 868. The image field 864, for example, may be configured to receive and display elements (e.g., the generated elements as described herein) that include image data. The header field 866 and caption field 868 may be configured to receive and display text data descriptive of headers and captions, respectively, associated with the image field 864. For example, the header and/or caption may, in some implementations, be generated as an element. Additionally or alternatively, in some implementations, the header and/or caption may be included in the element description data. It should be understood that the content template 860 is merely exemplary, and more or fewer fields may be included in a content template without departing from the present disclosure.

The content template 860 may be, for example, an “unordered” template. As illustrated in FIG. 8D, each of the groups 865 having the image field 864, the header field 866, and the caption field 868 are placed in an unordered manner about the content template 860. For example, each of the groupings 865 are neither aligned in a horizontal direction nor evenly spaced in a vertical direction. The content template 860, or a similar content template, may therefore be utilized by the systems and methods described herein when generating content items to convey information that reflects a similarly themed ordering. Additionally or alternatively, the content template 860 includes space for four groups 865, so the content template 860 may be selected if the element description data includes four elements.

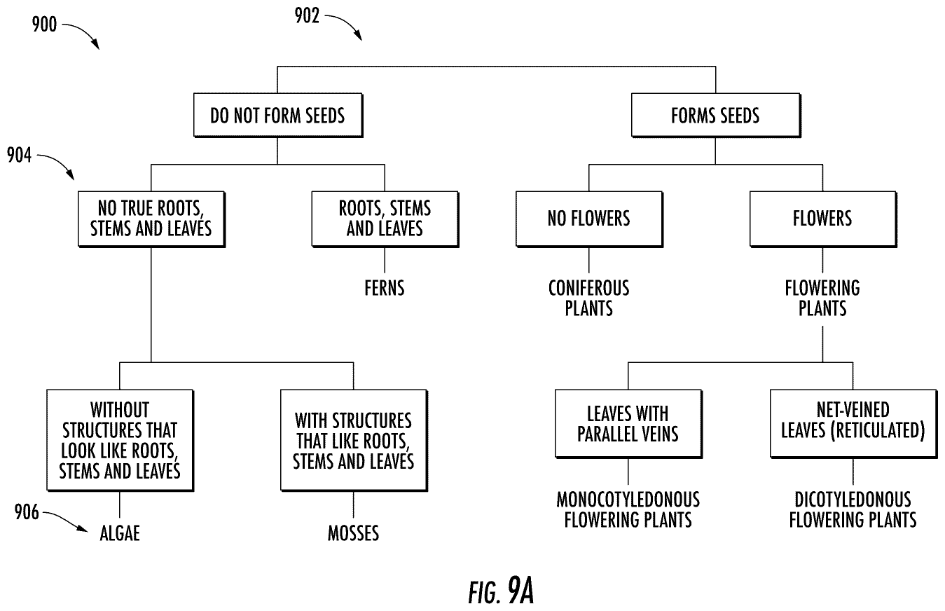

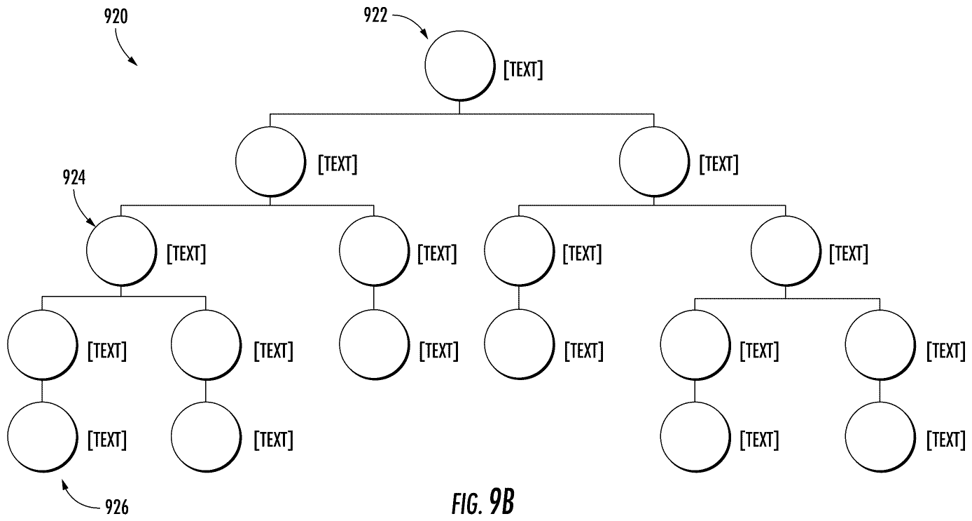

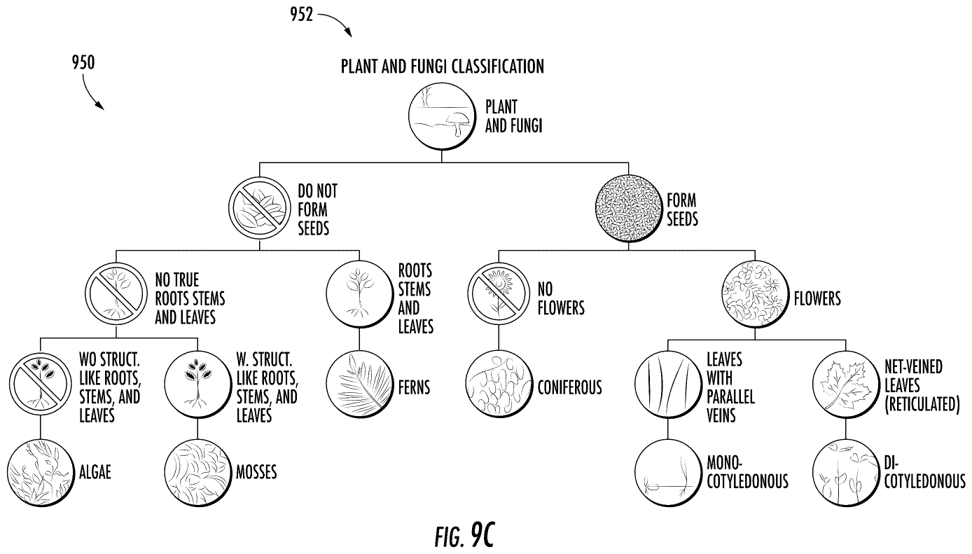

FIGS. 9A-9C are diagrams illustrating example structure-conforming generation of content according to example implementations of the present disclosure. In particular, FIG. 9A depicts an example element description data 900 according to some example implementations of the present disclosure. The element description data 900 can be or can include a hierarchical element description data. For instance, as illustrated in FIG. 9A, the element description data 900 can generally represent a tree data structure having a hierarchy from a root node 902 to leaf nodes 906, and including one or more intermediate nodes 904 (or, in some cases, simply referred to as nodes 904). The root node 902 can be a node with no superior node. For instance, the root node 902 can represent a first end (e.g., a highest end) in the order in the hierarchy of nodes. The leaf nodes 906 can have no subsequent nodes. For instance, the leaf nodes 906 can represent a second end (e.g., a lowest end) in the order in the hierarchy of nodes. The intermediate nodes 904 can include a superior node (e.g., the root node 902 or another intermediate node 904) and at least one subsequent node (e.g., another intermediate node 904 and/or a leaf node 906). The element description data 900 can therefore include a plurality of hierarchical “layers” or “tiers” including and between the root node 902 and the leaf nodes 906 that are descriptive of a relationship (e.g., a classification relationship) between the nodes 902, 904, and 906.

According to example implementations of the present disclosure, the systems and methods described herein can generate the element description data 900 such that the nodes 902, 904, and 906 are descriptive of and/or representative of elements in a content item to be generated. For instance, the root node 902 can be descriptive of a category or similar high-hierarchical element that broadly describes the other nodes 904 and/or 906. The subsequent nodes can increasingly narrow, describe, and/or illustrate the subject matter or topic of the element description data 900. For example, the element description data 900 could be represented as a hierarchical bulleted list, such as:
Plants and fungi
   Do not form seeds
      No true roots stems and leaves
         Without structure-like roots, stems, and leaves
         Algae
         With structure-like root, stems, and leaves
         Mosses
      Roots, stems, and leaves
         Ferns
   Form seeds
      No flowers
         Coniferous
      Flowers
         Leaves with parallel veins
         Mono-cotyledonous
         Net-veined leaves (reticulated)
         Di-cotyledonous

The element description data 900 can be represented by any suitable data structure or format. As one example, the element description data 900 can be represented by a JSON file. For instance, subsequent nodes can be represented using a “child” field or “subsequent” field or similar notational convention. As another example, the element description data 900 can be represented by a list data structure or linked list data structure.

In the example of FIG. 9A, for instance, the root node 902 describes that the content item will be related to classification of “plants and fungi.” The element description data 900 may have been generated in response to a user prompt such as “create a graphic classifying different types of plants and fungi.” The nodes 904 of the next hierarchical layer in the element description data 900 illustrate a classification between plants and fungi that “do not form seeds”and “form seeds.” After the “do not form seeds” node, a further classification is made between those with “no true roots, stems, and leaves” and those with “roots, stems, and leaves.” The next hierarchical layer classifies between “structure-like roots, stems, and leaves.” At the leaf nodes 906, examples of each classification of plants and fungi are given, such as “algae” for plants that do not form seeds and do not have structure-like roots, stems, and leaves. As illustrated, some hierarchical layers or tiers may include both intermediate nodes 904 and leaf nodes 906.

It should be understood that, in some implementations, the elements of the element description data 900 are generated by a machine-learned system or other artificial intelligence system, and aspects of those elements are described herein for the sole purpose of illustrating example implementation(s) of the present disclosure. Aspects of the element description data 900 described above need not necessarily be present in a given embodiment or implementation. Still further, in some cases, the systems and methods described herein may provide for the generation of element description data 900 that includes aspects beyond those discussed here. It is expressly contemplated herein that such an occurrence would not place that implementation outside of the scope of the present disclosure.

FIG. 9B is an example content template 920 responsive to the element description data 900 of FIG. 9A, according to example implementations of the present disclosure. The content template 920 may be, for example, a “hierarchical template” indicative of a hierarchical relationship between the elements of the content template 920. For example, a root node field 922 can include an image field and text field responsive to the root node 902 of the element description data 900. Similarly, intermediate node field(s) 924 can include an image field responsive to the intermediate node(s) 904 of the element description data 900. Furthermore, leaf node field(s) 926 can include an image field response to the leaf node(s) 906 of the element description data 900. In this manner, the content template 920 can be generated such that it can “fit” the elements set forth by the element description data 900. Images can be generated as described herein (e.g., from the description field in the element description data 900) to fill in the image fields of the content template 920. For example, the content template 920 can be generated to include a tree diagram having a plurality of tiers arranged in a descending relationship, where a first tier includes the root node field 922 corresponding to the root node 902, and subsequent tiers include a same number and/or arrangement of node fields (e.g., 924, 926) corresponding to the nodes (e.g., 904, 906) of the element description data 900. Relationships between the nodes (e.g., 904, 906) can be illustrated in the content template 920 by lines, flowchart arrows, or similar graphical elements between corresponding node fields (e.g., 924, 926).

FIG. 9C illustrates an example content item 950 according to example implementations of the present disclosure. For instance, the content item 950 can include a title 952 descriptive of the subject of the content item 950 (e.g., “plant and fungi classification) and a hierarchical diagram (e.g., a tree diagram) corresponding to the hierarchical diagram of the content template 920 of FIG. 9B. The image fields and/or text fields of the content template 920 can be populated with elements generated responsive to the element description data 900, as described herein. In this manner, the content item 950 can be a visually interesting tool for conveying information relating to its subject.

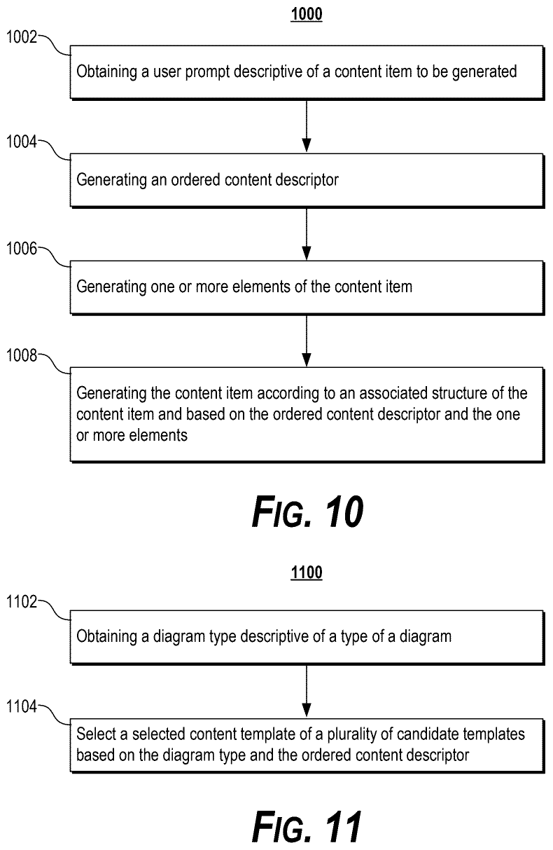

FIG. 10 is a flow chart diagram illustrating an example method 1000 for structure-conforming generation of content according to example implementations of the present disclosure. For example, the method 1000 can be implemented by any of the systems 100-500 of FIGS. 1-5 or any other suitable computing system. One or more portion(s) of the method 1000 can be implemented by a computing system that includes one or more computing devices such as, for example, computing systems described with reference to the other figures. Each respective portion of the method 1000 can be performed by any (or any combination) of one or more computing devices. Moreover, one or more portion(s) of the method 1000 can be implemented on the hardware components of the device(s) described herein, for example, to generate structure-conforming content as discussed herein. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, the method 1000 can include obtaining a user prompt. For example, a computing system can obtain the user prompt, such as a textual prompt, from a user. For instance, the user may provide the user prompt through an input field, such as a text input field configured to receive text data, or other suitable input field. For example, the user can provide the user prompt to a computing system with the objective of generating a content item using a content creation tool. In some implementations, the user prompt may be gathered through an interface element of a greater content creation tool, such as a slideshow creation tool, video creation tool, and so on. For example, the content item to be generated may be a slide of a slideshow.

The user prompt may be in the form of a query, or “plain language” data as written by the user. For instance, the user prompt can include text data. Additionally or alternatively, the user prompt can be descriptive of a content item to be generated. The user prompt can describe, for example, the style, content, arrangement, and/or other aspects of a content item that a user seeks to create by a content generation tool. The user prompt may describe aspects of the slide, such as the content of the slide, color, style, theme, or other stylistic aspects of the slide, and so on. Additionally or alternatively, the user prompt may not necessarily include every detail of the content item to be generated. For example, the user prompt may describe the content item at a high level, but may lack other details of the content item such as the style or particular arrangement details. For example, the user prompt may range from a request broadly describing the content to be generated, such as “please generate a slide depicting the life cycle of a chicken” to more specific requests such as “please generate a slide depicting the life cycle of a chicken as a circular diagram in a simple artistic style, using sketch-like drawings.” One example user prompt is the user prompt 602 of FIG. 6.

At 1004, the method 1000 can include generating element description data. The element description data can include a listing of descriptors or descriptions (e.g., plain text descriptions) of one or more elements of the content item to be generated. For example, the element description data can describe each element of the content item in a computer-interpretable format, such as plain text. The element description data can conform to a schema, such as, for example, a JavaScript Object Notation (JSON) schema, an Extended Markup Language (XML) schema, a Comma-Separated Value (CSV) schema, an INI schema, or other suitable schema. The schema can be indicative of syntax and validity of data of the element description data. Additionally or alternatively, the schema can be or can include an API call format. For instance, the element description data can be a “skeleton” representation of the elements of a content item, such as text data descriptive of images and captions to be displayed on a slide or graphic.

One example element description data can be a JSON file or other similar list having delineated values. The delineated values can correspond to the elements of the content item and/or can describe the element. For example, one element description data may include delineated values descriptive of four images representative of the life cycle of a butterfly; e.g., describing in text data the depiction of a butterfly egg on a leaf corresponding to an “egg” stage, a caterpillar on a leaf corresponding to a “larva” stage, a chrysalis hanging from a leaf corresponding to a “pupa” stage, and a butterfly in the air corresponding to an “adult” stage. Other values in the element description data may be descriptive of, for example, titles, captions, arrangements, etc. respective to each stage. For example, one example element description data can be the element description data 604 of FIG. 6.

At 1006, the method 1000 can include generating one or more elements of the content item. For instance, a computing system can generate the one or more elements of the content item to be generated based on the element description data. For instance, the computing system can produce, for each element described by the element description data, a data item that matches the description of the element in the element description data. As an example, if the element description data describes an element that is “an image depicting a butterfly egg on a leaf,” the computing system can generate an image depicting a butterfly egg on a leaf as the element. That element can eventually be combined with other elements to produce a larger content item that is thematically and stylistically consistent while also conforming to a structure associated with the content item, as described further herein.

At 1008, the method 1000 can include generating the content item. According to example aspects of the present disclosure, the content item can be generated responsive to the user prompt with elements that conform to a structure or format (e.g., file format) associated with the content item. The structure may be user-specified or program-specified. For example, the user may select, include in the user prompt, or otherwise indicate a particular structure or format that the user wishes for the content item to conform to. As another example, the structure may be specified based on the type of content item to be generated and/or a larger program or creative tool used to generate the content item. For example, if the user prompt is received from a slide show creation program, such as a program configured to create and edit slide show files (e.g., .ppt files, .odp files, etc.), the content item can be generated to conform to the slide show file format in use by the slide show creation program. As yet another example, in some implementations, the computing system can infer (e.g., by the first machine-learned model) or determine (e.g., by an association between types of content item and structures or formats) which structure to be used based on the user prompt. By conforming to a structure or format, the generated content can be modified by the user post-generation such that the user can, for example, replace or regenerate only some portion of the content item without entirely discarding the content item.

As one example, generating the content item can include combining the generated elements and/or portions of the element description data according to the structure. For example, the systems and methods of the present disclosure can be implemented as a “piecewise” generation of elements of a content item, where the elements are generated as independent data structures and combined according to the structure of the content item to produce the content item. For example, a structure may specify that images included in the content item are formatted according to a given data structure that includes the image data itself and/or metadata such as position of the image within the content item. The computing system can input the generated element into the data structure along with associated metadata and other information required by the structure. As another example, if the content item includes text data, the text data can be generated as an element or pulled from a respective field in the element description data (e.g., a title field or caption field). The text data can be stored according to a respective data structure within the structure, such as a data structure specifying the format for the text data and formatting for the text data, such as text size, text modifiers, font, and so on. In some implementations, generating the content item can be performed by implementing a generation script. For example, the generation script can be implemented to cause a computing system to parse the elements and relevant portions of the element description data into a structure-conforming content item.

In some implementations, the system may generate the content item relative to a content template. For example, in some implementations, the content template may be procedurally generated by a template generator to “fit” the elements based on the element description data. For instance, the system can determine an arrangement of elements specified by the element description data. The system (e.g., the template generator) can then generate the content template based on the arrangement of elements specified by the element description data. For example, as described further herein, the element description data can convey information relating to positional, conceptual, and/or other relationships between the elements. The template generator can produce the content template such that it includes placeholder elements corresponding to the elements. Additionally and/or alternatively, in some implementations, the content template can be descriptive of one or more display aspects of one or more placeholder elements corresponding to the one or more elements of the content item. The placeholder elements may be, for example, a partial element having some formatting, positional, or other display aspects that are shared with the elements. However, the placeholder elements may not include the content of the elements. Generating the content item can include applying the display aspects of the one or more placeholder elements to the one or more elements of the content item. For example, a placeholder element may be a slot or default item that is ultimately replaced with an element, while maintaining the position and/or formatting of the placeholder element, when generating the content item. The display aspects can be, for example, position, format, color, style, size, font, border, effect, or other suitable display aspect.

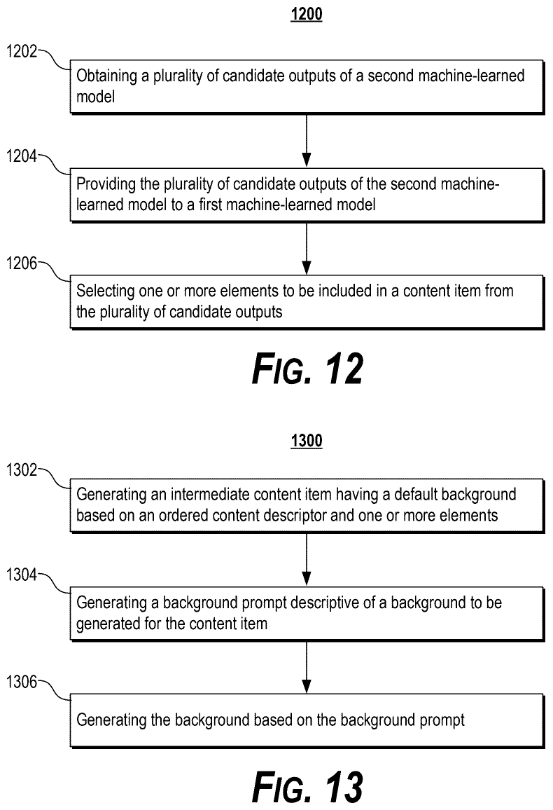

As another example, in some implementations, the system may generate the content item relative to a content template that is selected based on a type of the content item. For example, in some cases, the content item can be or can include a diagram. As one example, the content item can be a slide of a slideshow that depicts a diagram. The diagram may be a focal portion of the content item (e.g., the slide), but additional elements may be included in the diagram that do not necessarily conform to the selected type of diagram (e.g., a title, a source citation, a legend, etc.). As another example, the content item can be the diagram itself. One approach for generating the content item relative to a type of the content item and/or based on a content template selected based on the diagram type is discussed below with reference to FIG. 11.

FIG. 11 is a flow chart diagram illustrating an example method 1100 for structure-conforming generation of content according to example implementations of the present disclosure. For example, the method 1100 can be implemented by any of the systems 100-500 of FIGS. 1-5 or any other suitable computing system. One or more portion(s) of the method 1100 can be implemented by a computing system that includes one or more computing devices such as, for example, computing systems described with reference to the other figures. Each respective portion of the method 1100 can be performed by any (or any combination) of one or more computing devices. Moreover, one or more portion(s) of the method 1100 can be implemented on the hardware components of the device(s) described herein, for example, to generate structure-conforming content as discussed herein. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of example method 1100 can be performed additionally, or alternatively, by other systems.

At 1102, the method 1100 includes obtaining a diagram type descriptive of a type of the diagram. The diagram type can, in some implementations, be specified by the user (e.g., via the user prompt). Additionally or alternatively, the computing system (e.g., the first machine-learned model) can determine a diagram type that represents the content displayed in the diagram. The diagram type, for example, can relate to the manner in which the elements of the diagram are displayed or positioned. As one example, the diagram type may specify a “cycle” diagram generally depicted as multiple stages positioned in a circular or ovular fashion. For instance, the cycle diagram may be useful for depicting life cycles, weather patterns, iterative steps, and other phenomena that are cyclical in nature. As another example, the type may specify an “ordered” diagram such as one or more stages positioned in a linear fashion. An ordered diagram may be useful for depicting linear processes, flowcharts, and so on. As yet another example, the type may specify an “unordered” diagram such as one or more stages positioned in a seemingly irregular arrangement.

At 1104, the method 1100 can include selecting a selected content template of a plurality of candidate templates based on the diagram type and the element description data. For instance, based on the diagram and/or the number of elements in the content item or diagram, the computing system can select a content template for the content item that is appropriate for the diagram and the content item. Additionally or alternatively, the computing system can select a selected content template based on a number of elements to be displayed in the diagram. For instance, in some implementations, the element description data can include a number of the one or more elements. The element description data can include the number of elements implicitly based on the number of fields and/or explicitly based on a value of a dedicated field describing the number of elements. The selected content template can be selected based on the number of the one or more elements. For instance, if the element description data describes five elements in a diagram, the computing system can select a content template having five placeholder elements.

The computing system can then generate (e.g., as in step 1008 of FIG. 10) the content item according to the associated structure of the content item and based on the element description data and the one or more elements, and further based on the selected content template. For example, the computing system can position and/or format the elements within the content item based on the selected content template. In some implementations, the content template can be a structural template; for instance, it can be descriptive of one or more display aspects of one or more placeholder elements corresponding to the one or more elements of the content item. The display aspects can be, for example, position, format, color, style, size, font, border, effect (e.g., shading, transition effects, etc.), and other suitable aspects or metadata relative to an element. For instance, the content template can be data descriptive of positional relationships, sizes, formatting, color, and so on for elements of the content item and/or additional (e.g., graphical) elements to be included in the content item, without necessarily being dependent on the content of the elements themselves. As one example, the content template can describe positions of five images in a cyclical diagram in a center of a slide, but may not describe the five images themselves. As another example, the content template may describe that 12 point red Times New Roman font is located at a given position in the infographic, but may not describe the characters of the text.

The content template may be, for example, a template slide of a slideshow editor. The selected content template can be responsive to the display requirements of the element description data. For instance, if the element description data contains four elements and the type of diagram is a cycle diagram, the selected content template may describe four element positions arranged in a cycle. Additionally or alternatively, the selected content template may include arrows or other graphics depicting a cyclical relationship. Some example content templates are depicted in FIGS. 8A-8D .

Returning to FIG. 10, in some implementations, the content item can be generated by or using one or more machine-learned models. For instance, in some implementations, generating the element description data (e.g., step 1004) and generating the one or more elements (e.g., step 1006) can be performed using one or more machine-learned models. In some implementations, a single machine-learned model (e.g., a general-purpose machine-learned model) can perform some or all of the steps of method 1000. For instance, the machine-learned model can receive the user prompt, generate element description data based on the user prompt, generate elements of the content item based on the user prompt, and/or generate the content item based on the user prompt and elements such that the content item conforms to an associated style.

Additionally or alternatively, in some implementations, two or more machine-learned models can perform steps described herein. As one example, generating the element description data can be performed using a first machine-learned model and/or generating the one or more elements can be performed using a second machine-learned model. As one example, the user prompt can be provided to a first machine-learned model. The first machine-learned model can be a model configured to interpret text data, such as a language model (e.g., a large language model). In response to the user prompt, the first machine-learned model can output the element description data. In some implementations, at least one of the one or more machine-learned models can be instructed to produce outputs conforming to the schema. For example, the system can provide instructions to the first machine-learned model instructing it to condition its outputs to conform to the schema prior to providing it with the user prompt. As another example, the element description data can be provided to a second machine-learned model, such as an image generation model. The image generation model may be, for example, a diffusion model or an autoregressive model. In response to the element description data, the second machine-learned model can generate the elements of the content item as specified by the element description data. Based on the element description data, the second machine-learned model can produce elements matching the descriptions of the elements of the content item. For instance, the examples above may cause the second machine-learned model to produce images of a butterfly egg, a caterpillar, a chrysalis, and a butterfly.

If details of the content item are not specified by the user prompt, the computing system may infer some or all of the unspecified details to generate interesting content items. For instance, the use of machine-learned models as described herein can provide for inferring unspecified details based on the context of the user prompt, even if that context is minimal. For example, if a user prompt instructs the computing system to generate a slide depicting a life cycle of a chicken without additional information, the computing system may infer thematic elements associated with farms, poultry, birds, and so on based on the learned associations of the machine-learned models between tokens such as “chicken” and “farm,” “wheat,” “checkered,” “plaid,” and so on, based on the training data provided to the computing system. The slide that is generated may therefore include these stylistic elements, even without requiring explicit input from the user. For example, the generated slide may include a background depicting a barn or chicken coop, or stylistic elements may resemble checkered fabric or plaid, wrought-iron tools, picket fences, or other graphical elements typically associated with the “chicken” token and other nearby tokens. For instance, in one example, the first machine-learned model (e.g., a language model) may generate or otherwise utilize tokens that are proximate to the “chicken” token on a spatial plot of learned token associations, such as, for example, “farm,” “wheat,” “corn,” “checkered,” and similar tokens. The element description data that is generated may therefore include some or all of these tokens. When the element description data is passed to a second machine-learned model (e.g., an image generation model), the second machine-learned model may generate elements that are at least partially responsive to these proximate tokens. For example, an image generation model may generate images that depict wheat, corn, checkered fabric, and so on. These images can be combined according to the element description data to produce a thematically-consistent slide with a theme that may generally be described as “chicken ranching” or “farm life” or other similar agrarian theme. As another example, if a user prompt instructs the computing system to generate a slide depicting a life cycle of a butterfly, again without any additional information, the computing system may infer thematic elements associated with flowers, trees, forests, nature and other items that are typically associated with the “butterfly” token. In this manner, the user can receive aesthetically pleasing and thematically consistent content items even in the case of minimal interaction from the user.

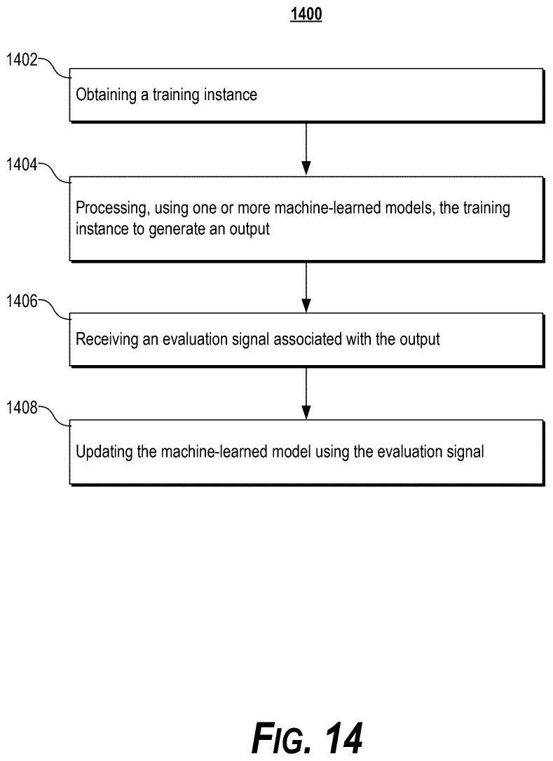

In some implementations, the elements can be selected from several potential or candidate outputs of the machine-learned models. For example, the models can be instructed to produce a plurality of outputs, and a desired output can be selected from the plurality of outputs. One example approach for selecting elements from a plurality of candidate outputs is discussed below with reference to FIG. 12.

FIG. 12 is a flow chart diagram illustrating an example method 1200 for structure-conforming generation of content according to example implementations of the present disclosure. For example, the method 1200 can be implemented by any of the systems 100-500 of FIGS. 1-5 or any other suitable computing system. One or more portion(s) of the method 1200 can be implemented by a computing system that includes one or more computing devices such as, for example, computing systems described with reference to the other figures. Each respective portion of the method 1200 can be performed by any (or any combination) of one or more computing devices. Moreover, one or more portion(s) of the method 1200 can be implemented on the hardware components of the device(s) described herein, for example, to generate structure-conforming content as discussed herein. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of example method 1200 can be performed additionally, or alternatively, by other systems.

At 1202, the method 1200 can include obtaining a plurality of candidate outputs of the second machine-learned model (e.g., the image generation model). The plurality of candidate outputs can be responsive to the descriptors of the one or more elements in the element description data. For example, each of the candidate outputs may include a plurality of candidate elements that generally correspond to the elements of the element description data, but may be generated by different seeding or other inputs such that the candidate elements corresponding to a given desired element are not necessarily identical.

The computing system can, e.g. by or using another machine-learned model such as the first machine-learned model as an adversarial model, select the one or more elements of the content item from the plurality of candidate outputs. For instance, the method 1200 can include, at 1204, providing the plurality of candidate outputs of the second machine-learned model to the first machine-learned model. In addition to the candidate outputs themselves, in some implementations, the first machine-learned model may additionally be provided with instructions to cause the model to interpret the elements in an adversarial manner. For example, the model may be prompted with a selection prompt based on the user prompt or the element description data. As one example, the selection prompt may be a phrase such as “Which of these images is best at showing <element>” where “<element>” is or is based on the descriptor of an element in the element description data.

The method 1200 can further include, at 1206, selecting the one or more elements to be included in the content item from the plurality of candidate outputs. The computing system may select an element that scores highly relative to the descriptor of the element from the candidate outputs. For example, if the first model is prompted with an instruction such as “which of these images is best at showing” some given aspect, the model may assign rankings to each candidate element in the candidate outputs based on the given aspect and select the highest-ranking candidate element (or some other high-ranking candidate element). In some cases, the elements may be selected from among multiple candidate outputs. For example, a first element may be selected from a first candidate output, and a second element can be selected from a second candidate output. Furthermore, in some implementations, the candidate elements may be grouped based on which element in the element description data they correspond to, and a candidate element from each group may be selected. For example, in the “life cycle of a chicken” example, each stage of the life cycle can be a group, such as an “egg” group where each candidate element is generated in response to the description of the “egg” life cycle stage in the element description data.

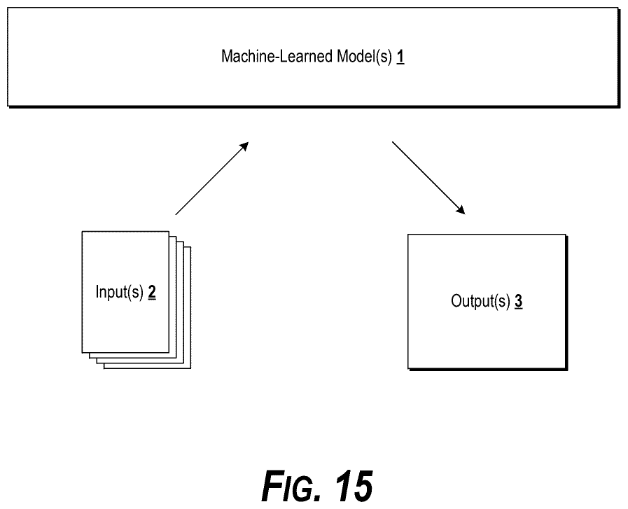

Returning to FIG. 10, in some implementations, the computing system may generate a background for a content item based on the elements of the content item. For example, the background can be thematically consistent with the elements and the other portions of the content item. In some implementations, the background can be generated along with the other elements of the content item. Additionally or alternatively, in some implementations, the background can be generated by a background generation system subsequent to the other elements. One example approach for generating a background item is discussed below with reference to FIG. 13.

FIG. 13 is a flow chart diagram illustrating an example method 1300 for structure-conforming generation of content according to example implementations of the present disclosure. For example, the method 1300 can be implemented by any of the systems 100-500 of FIGS. 1-5 or any other suitable computing system. One or more portion(s) of the method 1300 can be implemented by a computing system that includes one or more computing devices such as, for example, computing systems described with reference to the other figures. Each respective portion of the method 1300 can be performed by any (or any combination) of one or more computing devices. Moreover, one or more portion(s) of the method 1300 can be implemented on the hardware components of the device(s) described herein, for example, to generate structure-conforming content as discussed herein. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of example method 1300 can be performed additionally, or alternatively, by other systems.

At 1302, the method 1300 can include generating an intermediate content item based on the element description data and the one or more elements. The intermediate content item can have a default background. For example, the intermediate content item may have a solid black or white background, a transparent background, or other background that is a default for a creation tool. In addition to or alternatively to having a default background, the intermediate content item may not have any background.

At 1304, the method 1300 can include generating a background prompt descriptive of a background to be generated for the content item. For instance, the computing system can generate a background prompt based on the element description data and/or the elements or, additionally or alternatively, based on the intermediate content item that lacks a customized background. For example, the background prompt can describe the background to be generated in plain language (e.g., text data).

At 1306, the method 1300 can include generating the background based on the background prompt. For example, the computing system can generate a background that is responsive to the background prompt. The background can be, for example, an image, gradient, or other suitable background. Generating the content item according to the associated structure of the content item and based on the element description data and the one or more elements can further be based on the background. For example, the background can be combined with the intermediate content item (e.g., in a background field of the structure) to produce the final content item. For example, in some implementations, the background, the intermediate content item, the elements, and/or the element description data can be provided to a generation script configured to combine the items to generate the content item.

In some implementations, one or more machine-learned models can be used to generate the background. As one example, the first machine-learned model (e.g., the model used to generate the element description data) can generate the background prompt based on the intermediate content item such that the background prompt describes thematic or stylistic elements that are consistent with similar thematic or stylistic elements of the elements. The second machine-learned model (e.g., the model used to generate the elements) can generate the background based on the background prompt.

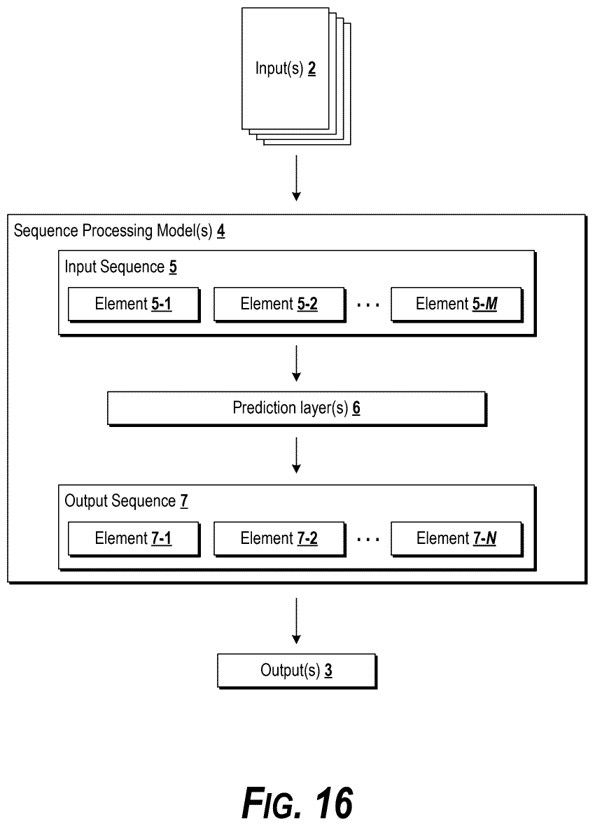

FIG. 14 depicts a flowchart of a method 1400 for training one or more machine-learned models according to aspects of the present disclosure. For instance, an example machine-learned model can include the first machine-learned model 210 or the second machine-learned model 220 of FIG. 2, a language model, an image generation model, or other machine-learned models or machine-learned components discussed herein.

One or more portion(s) of example method 1400 can be implemented by a computing system that includes one or more computing devices such as, for example, computing systems described with reference to the other figures. Each respective portion of example method 1400 can be performed by any (or any combination) of one or more computing devices. Moreover, one or more portion(s) of example method 1400 can be implemented on the hardware components of the device(s) described herein, for example, to train one or more systems or models. FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of example method 1400 can be performed additionally, or alternatively, by other systems.

At 1402, example method 1400 can include obtaining a training instance. A set of training data can include a plurality of training instances divided between multiple datasets (e.g., a training dataset, a validation dataset, or testing dataset). A training instance can be labeled or unlabeled. Although referred to in example method 1400 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1404, example method 1400 can include processing, using one or more machine-learned models, the training instance to generate an output. The output can be directly obtained from the one or more machine-learned models or can be a downstream result of a chain of processing operations that includes an output of the one or more machine-learned models.

At 1406, example method 1400 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1408, example method 1400 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1400 can include implementing a number of generalization techniques (e.g., weight decays, dropouts, etc.) to improve the generalization capability of the models being trained.

In some implementations, example method 1400 can be implemented for training a machine-learned model from an initialized state to a fully trained state (e.g., when the model exhibits a desired performance profile, such as based on accuracy, precision, recall, etc.).

In some implementations, example method 1400 can be implemented for particular stages of a training procedure. For instance, in some implementations, example method 1400 can be implemented for pre-training a machine-learned model. Pre-training can include, for instance, large-scale training over potentially noisy data to achieve a broad base of performance levels across a variety of tasks/data types.

In some implementations, example method 1400 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 1400 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 1400 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

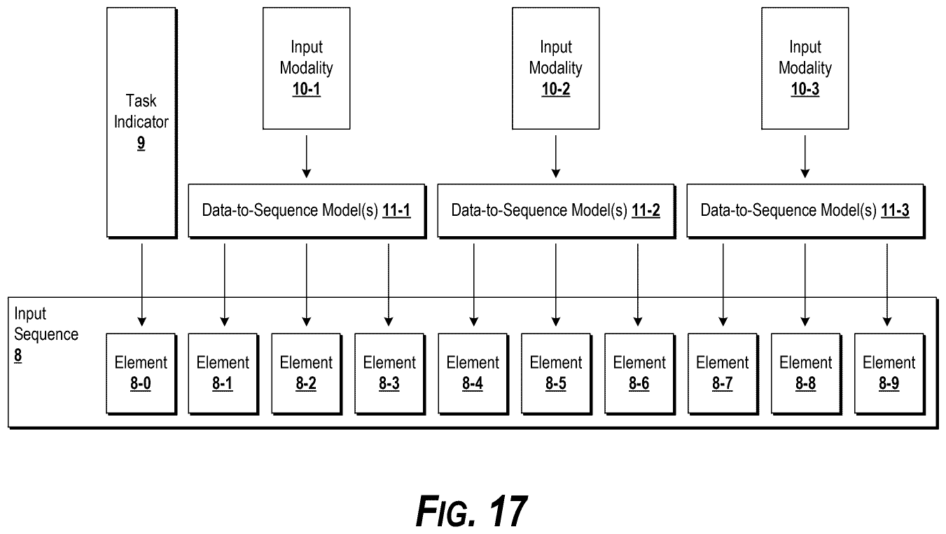

FIG. 15 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of, for example, first machine-learned model 210 of FIG. 2, second machine-learned model 220 of FIG. 2, etc. Although various features, variations, and implementations described below are described with respect to machine-learned model(s) 1, it is to be understood that such features, variations, and implementations are to be understood as described with respect to each of the machine-learned models (e.g., first machine-learned model 210, second machine-learned model 220) or any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

FIG. 16 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport. pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON E MPIRICAL METHODS IN NATURAL LANGUAGE PROCESSING (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 16 can be the tokens or can be the embedded representations thereof.

Prediction layer(s) 6 can predict one or more output elements 7-1, 7-2 , . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and regenerating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

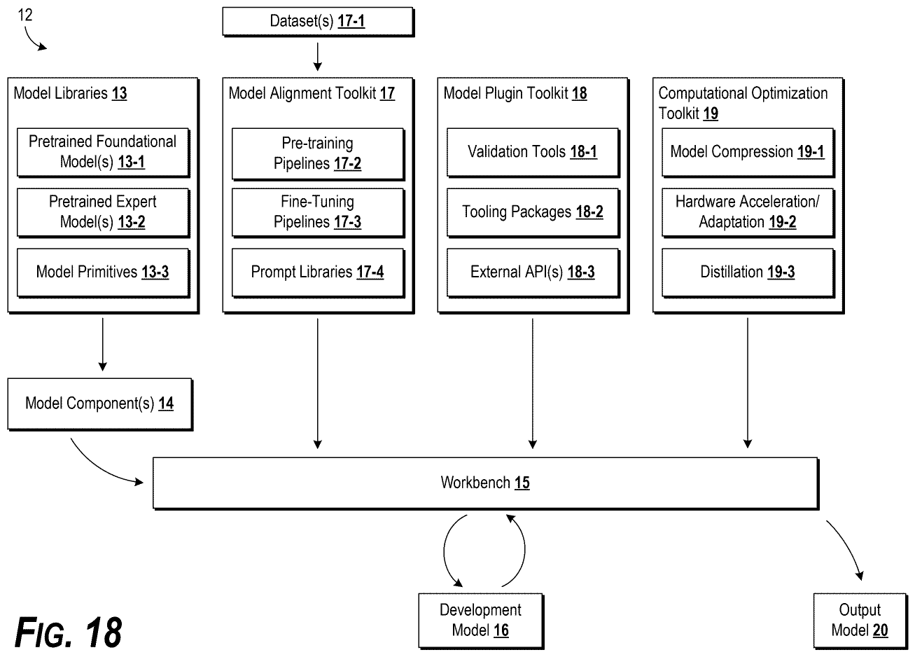

FIG. 17 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

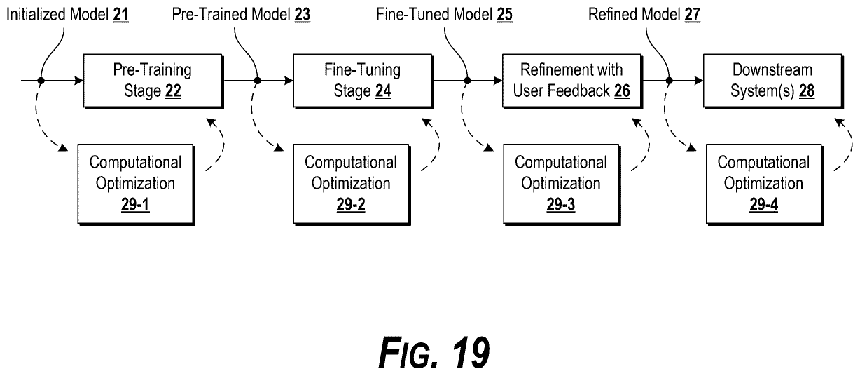

FIG. 18 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1300 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

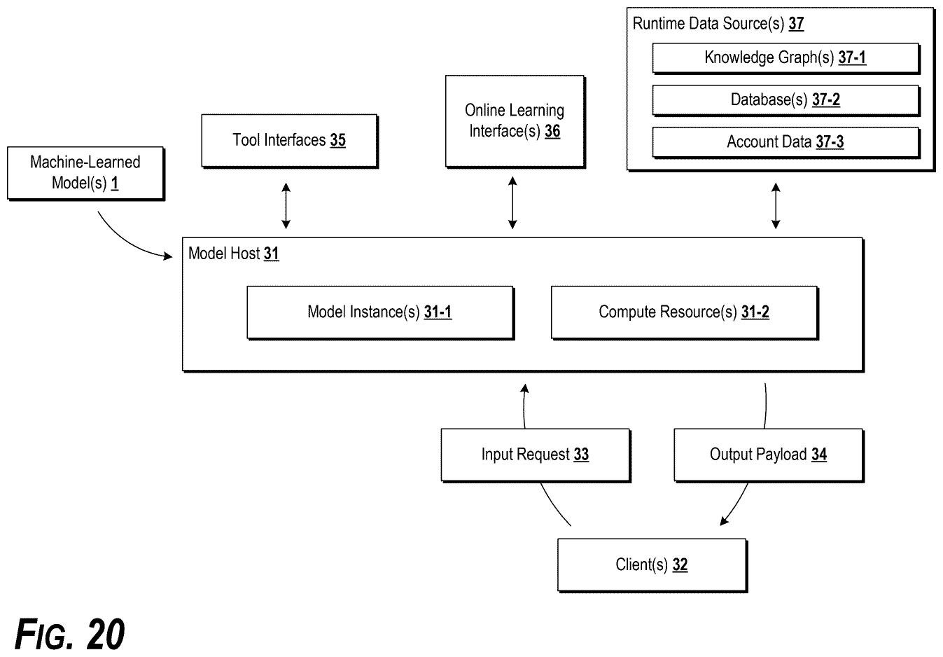

FIG. 19 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 18 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 18 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

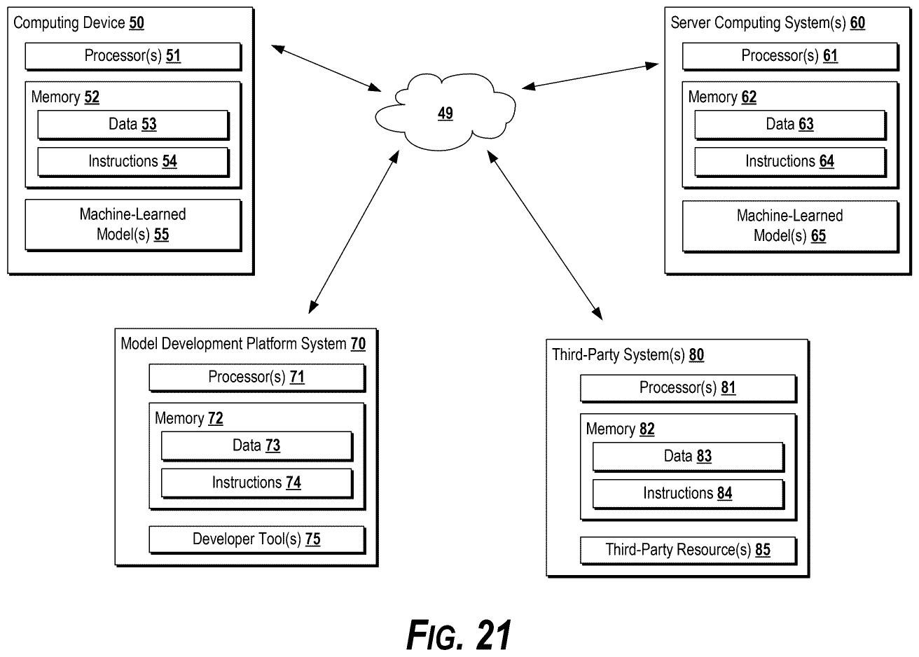

FIG. 20 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on or in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

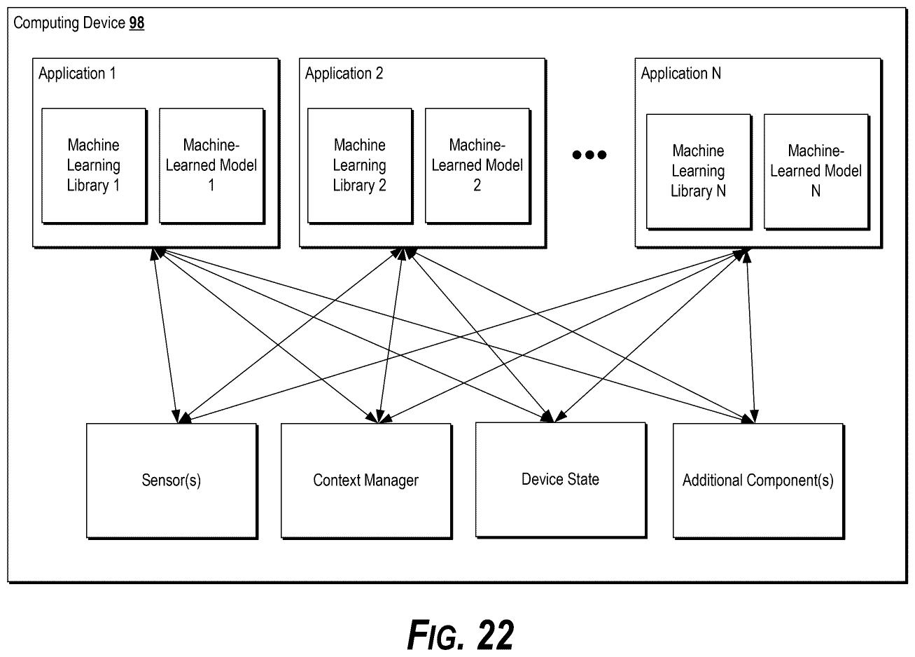

FIG. 21 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 21 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, Light Detection and Ranging system (LIDAR), a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, random access memory (RAM), read-only memory (ROM), EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 21 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

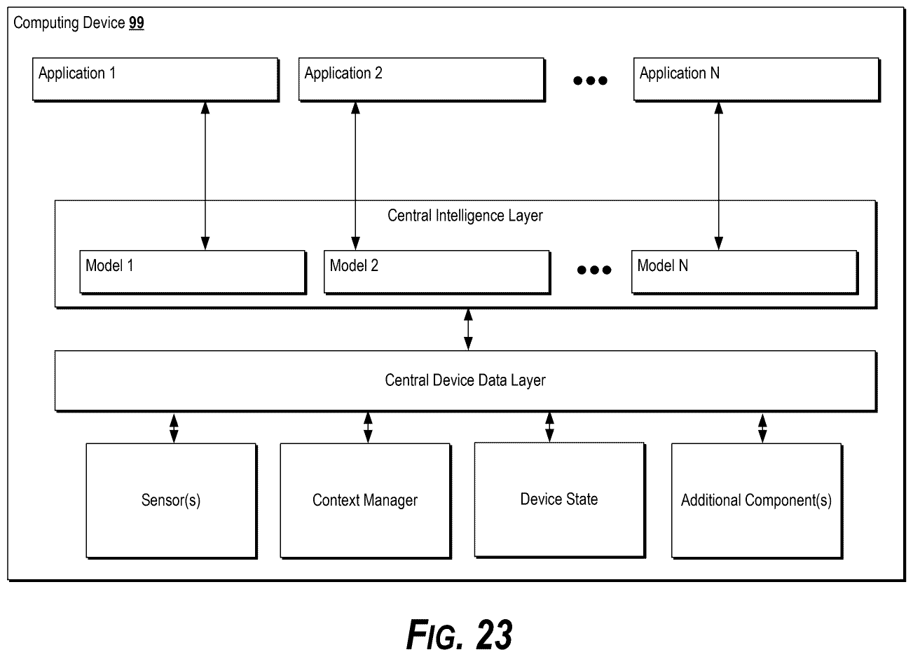

FIG. 22 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 22, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 23 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 23, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 23, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method of generating structure-conforming content items, the method comprising:
obtaining, by a computing system comprising one or more computing devices, a user prompt descriptive of a content item to be generated;
generating, by the computing system, element description data, the element description data conforming to a schema, the element description data comprising a listing of descriptors of one or more elements of the content item to be generated;
generating, by the computing system, the one or more elements of the content item; and
generating, by the computing system, the content item according to an associated structure of the content item and based on the element description data and the one or more elements.

2. The computer-implemented method of claim 1, wherein generating the element description data and generating the one or more elements are performed using one or more machine-learned models.

3. The computer-implemented method of claim 2, wherein the method further comprises instructing at least one of the one or more machine-learned models to produce outputs conforming to the schema.

4. The computer-implemented method of claim 2, wherein generating the element description data is performed using a first machine-learned model and wherein generating the one or more elements is performed using a second machine-learned model.

5. The computer-implemented method of claim 4, wherein generating the one or more elements of the content item comprises:
obtaining, by the computing system, a plurality of candidate outputs of the second machine-learned model, the plurality of candidate outputs responsive to the descriptors of the one or more elements;
providing, by the computing system, the plurality of candidate outputs of the second machine-learned model to the first machine-learned model; and
selecting, by the computing system, the one or more elements of the content item from the plurality of candidate outputs.

6. The computer-implemented method of claim 4, wherein the first machine-learned model comprises a language model and wherein the second machine-learned model comprises an image generation model.

7. The computer-implemented method of claim 6, wherein the image generation model comprises one or more of a diffusion model or an autoregressive model.

8. The computer-implemented method of claim 1, wherein the schema comprises a JavaScript Object Notation (JSON) schema.

9. The computer-implemented method of claim 1, wherein the method further comprises:
generating, by the computing system, an intermediate content item based on the element description data and the one or more elements, the intermediate content item having a default background;
generating, by the computing system, a background prompt descriptive of a background to be generated for the content item; and
generating, by the computing system, the background based on the background prompt;
wherein generating the content item according to the associated structure of the content item and based on the element description data and the one or more elements is further based on the background.

10. The computer-implemented method of claim 1, wherein the method further comprises obtaining, by the computing system, a content template for the content item based on the element description data;
wherein generating, by the computing system, the content item according to the associated structure of the content item and based on the element description data and the one or more elements is further based on the content template.

11. The computer-implemented method of claim 10, wherein obtaining the content template comprises:
obtaining, by the computing system, a diagram type descriptive of a type of a diagram of the content item; and
selecting, by the computing system, the content template from a plurality of candidate templates based on the diagram type and the element description data.

12. The computer-implemented method of claim 10, wherein obtaining the content template comprises:
determining, by the computing system, an arrangement of elements specified by the element description data; and
generating the content template based on the arrangement of elements specified by the element description data.

13. The computer-implemented method of claim 10, wherein the content template is descriptive of one or more display aspects of one or more placeholder elements corresponding to the one or more elements of the content item.

14. The computer-implemented method of claim 13, wherein generating the content item further comprises applying the display aspects of the one or more placeholder elements to the one or more elements of the content item.

15. The computer-implemented method of claim 13, wherein the display aspects comprise one or more of: position, format, color, style, size, font, border, or effect.

16. A computing system, comprising:
one or more processors; and
one or more non-transitory, computer-readable media storing instructions that, when implemented, cause the one or more processors to perform operations, the operations comprising:
obtaining a user prompt descriptive of a content item to be generated;
generating element description data, the element description data conforming to a schema, the element description data comprising a listing of descriptors of one or more elements of the content item to be generated;
generating the one or more elements of the content item based on the element description data; and
generating the content item according to an associated structure of the content item and based on the element description data and the one or more elements.

17. The computing system of claim 16, wherein generating the element description data and generating the one or more elements are performed using one or more machine-learned models.

18. The computing system of claim 16, wherein generating the element description data is performed using a first machine-learned model and wherein generating the one or more elements is performed using a second machine-learned model; and
wherein generating the one or more elements of the content item comprises:
obtaining a plurality of candidate outputs of the second machine-learned model, the plurality of candidate outputs responsive to the descriptors of the one or more elements;
providing the plurality of candidate outputs of the second machine-learned model to the first machine-learned model; and
selecting the one or more elements of the content item from the plurality of candidate outputs.

19. The computing system of claim 16, wherein the operations further comprise:
generating an intermediate content item based on the element description data and the one or more elements, the intermediate content item having a default background;
generating a background prompt descriptive of a background to be generated for the content item; and
generating the background based on the background prompt;
wherein the content item according to the associated structure of the content item and based on the element description data and the one or more elements is further based on the background.

20. One or more non-transitory, computer-readable media storing instructions that, when implemented, cause one or more processors to perform operations, the operations comprising:
obtaining a user prompt descriptive of a content item to be generated;
generating element description data, the element description data conforming to a schema, the element description data comprising a listing of descriptors of one or more elements of the content item to be generated;
generating the one or more elements of the content item based on the element description data; and
generating the content item according to an associated structure of the content item and based on the element description data and the one or more elements.
